(19) United States
(12) Patent Application Publication
(10) Pub. No.: US 2026/0084436 A1
(43) Pub. Date: Mar. 26, 2026

(54) IMAGE PROCESSING APPARATUS

(71) Applicant: CANON KABUSHIKI KAISHA, Tokyo (JP)

(72) Inventors: DAISUKE KOBAYASHI, Kanagawa (JP); FUMIKO SUZUKI, Tokyo (JP)

(21) Appl. No.: 19/339,997

(22) Filed: Sep. 25, 2025

(30) Foreign Application Priority Data
Sep. 26, 2024 (JP) 2024-167826

(51) Int. Cl. B41J 2/21; B41J 11/00; G06K 15/02; G06K 15/10

(52) U.S. Cl. CPC B41J 2/2132; B41J 2/2103; B41J 11/0095; G06K 15/102; G06K 15/1847; G06K 15/1873

(57) ABSTRACT

As a result of the processing by the dot arrangement unit, dots are arranged so that in a first edge pixel group located in a first end portion of the object in the scanning direction and adjacent to a boundary between the object and an outside of the object, a ratio of arranging dots in the second regions is lower than a ratio of arranging dots in the first regions, and in a second edge pixel group adjacent to the boundary and located in a second end portion different from the first end portion and on a opposite side of the first end portion in the scanning direction, a ratio of arranging dots in the first regions is lower than a ratio of arranging dots in the second regions.

### BACKGROUND

### Field of the Technology

The present disclosure relates to an image processing apparatus.

### Description of the Related Art

There is generally known a technique (to be referred to as edge processing hereinafter) of changing print processing by detecting the edges of an image to improve the sharpness of a printed character or line in a printing apparatus for printing a color material on a print medium. Japanese Patent Laid-Open No. 2003-191456 discloses a technique of thinning the print dots of the edge pixels of an object to reduce a deterioration in image quality caused by bleeding of printed ink on a print medium in an inkjet printing apparatus.

### SUMMARY

In a case where the dots of the edges of an object are only thinned, as described in Japanese Patent Laid-Open No. 2003-191456, this is insufficient to obtain desired quality on a print medium since ink bleeds around a portion where the dots are arranged.

The present disclosure provides an image processing apparatus for further improving image quality in edge portions of an object.

The present disclosure in one aspect provides an image processing apparatus comprising: a print unit configured to print dots on a print medium by discharging ink droplets on the print medium, and configured to be able to print dots at a resolution higher than a resolution of image data and relatively move in a scanning direction with respect to the print medium; and a dot arrangement unit configured to perform processing of arranging a dot in a pixel based on the image data including an object, wherein the print unit includes a first nozzle array configured to be able to print a dot in a first region of each pixel of the object, and a second nozzle array configured to be able to print a dot in a second region of each pixel of the object, and the first region and the second region are arranged in a direction orthogonal to the scanning direction, as a result of the processing by the dot arrangement unit, dots are arranged so that in a first edge pixel group located in a first end portion of the object in the scanning direction and adjacent to a boundary between the object and an outside of the object, a ratio of arranging dots in the second regions is lower than a ratio of arranging dots in the first regions, and in a second edge pixel group adjacent to the boundary and located in a second end portion different from the first end portion and on a opposite side of the first end portion in the scanning direction, a ratio of arranging dots in the first regions is lower than a ratio of arranging dots in the second regions, and a positional relationship between an array of the dots arranged in the first regions of the pixels in the scanning direction of the object and an array of the dots arranged in the second regions of the pixels in the scanning direction of the object is uniformly shifted in the scanning direction so that a width in the scanning direction of the object is narrow.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view showing an overview of a print unit;

FIGS. 2A and 2B are a view and a block diagram showing the configuration of a printing system;

FIGS. 3A to 3C are flowcharts illustrating processing executed by an image processing unit;

FIGS. 4A to 4C are views for explaining edge pattern detection;

FIG. 5 is a view for explaining edge pattern detection;

FIG. 6 is a flowchart illustrating processing executed by the image processing unit;

FIGS. 7A to 7C are a flowchart, a table, and a graph for explaining color separation/quantization processing and nozzle separation processing;

FIGS. 8A to 8D are views showing a dot arrangement pattern and a reference index pattern;

FIGS. 9A to 9C are views for explaining the structure of a printhead;

FIGS. 10A to 10D are flowcharts and views for explaining the color separation/quantization processing and the nozzle separation processing;

FIG. 11 is a view for explaining the flight characteristic of a main droplet and satellites;

FIG. 12 is a view schematically showing a state in which a main droplet and satellites land on a print medium;

FIG. 13 is a view schematically showing a state in which a main droplet and satellites land on a print medium;

FIGS. 14A to 14G are views for explaining edge processing;

FIGS. 15A to 15E are views for explaining the edge processing;

FIGS. 16A to 16E are views for explaining adjustment of a dot position;

FIGS. 17A to 17C are views for explaining adjustment of a dot position;

FIGS. 18A and 18B are views for explaining the edge processing;

FIGS. 19A and 19B are views each showing a dot arrangement;

FIGS. 20A to 20I are views each showing a dot arrangement;

FIGS. 21A to 21F are views for explaining edge processing;

FIGS. 22A to 22F are views each showing a dot arrangement;

FIGS. 23A to 23E are views for explaining a case where an input image is square;

FIGS. 24A and 24B are flowcharts illustrating processing executed by an image processing unit;

FIGS. 25A to 25C are a flowchart and views for explaining processing using a quantization table; and

FIGS. 26A and 26B are a flowchart and a graph showing processing executed by an image processing unit.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made the disclosure that requires all such features, and multiple such features may be combined as appropriate. Furthermore, in the attached drawings, the same reference numerals are given to the same or similar configurations, and redundant description thereof is omitted.

In a case where the dots of the edges of an object are only thinned, as described in Japanese Patent Laid-Open No. 2003-191456, this is insufficient to obtain desired quality on a print medium since ink bleeds around a portion where the dots are arranged.

According to the present disclosure, it is possible to further improve image quality in edge portions of an object.

### <Structure of Printing Apparatus>

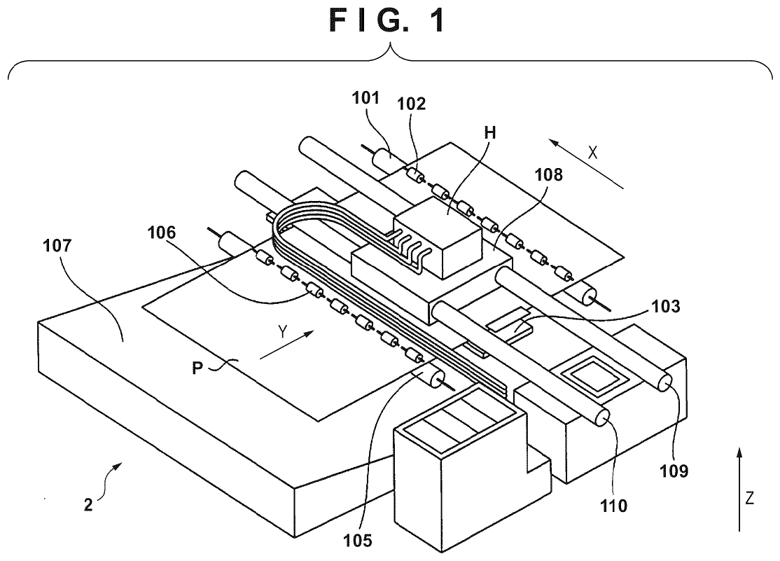

The structure of a printing apparatus according to an embodiment will be described below with reference to FIG. 1. FIG. 1 is a perspective view showing an overview of a print unit in a printing apparatus 2 (to be also simply referred to as a printing apparatus/printer hereinafter). A print medium P (to be also simply referred to as a print medium hereinafter) fed to the print unit is conveyed in the −Y direction (sub-scanning direction) by a nip portion between a conveyance roller 101 arranged on a conveyance path and a pinch roller 102 driven by the conveyance roller 101 along with the rotation of the conveyance roller 101. A platen 103 is provided at a print position facing a surface (nozzle surface) on which nozzles of a printhead H adopting an inkjet printing method are formed, and maintains the distance between the front surface of the print medium P and the nozzle surface of the printhead H constant by supporting the back surface of the print medium P from below. The print medium P whose region is printed on the platen 103 is conveyed in the −Y direction along with the rotation of the discharge roller 105 while being nipped by a discharge roller 105 and a spur 106 driven by the discharge roller 105, and is then discharged to a discharge tray 107.

The printhead H is detachably mounted on a carriage 108 in a posture that the nozzle surface faces the platen 103 or the print medium. The carriage 108 can be moved reciprocally in the X direction as the main scanning direction along two guide rails 109 and 110 by the driving force of a carriage motor (not shown). In the process of the movement, the printhead H executes a discharge operation according to a discharge signal. The ±X direction in which the carriage 108 moves is a direction orthogonal to the −Y direction in which the print medium is conveyed, and is called the main scanning direction. To the contrary, the −Y direction of conveyance of the print medium is called the sub-scanning direction. By alternately repeating main scanning (movement with a discharge operation) of the carriage 108 and the printhead H and conveyance (sub-scanning) of the print medium, an image is formed stepwise on the print medium P. Main scanning in the +X direction of the printhead H will be referred to as forward scanning hereinafter and main scanning in the −X direction will be referred to as backward scanning hereinafter. The contents of the structure of the printing apparatus according to this embodiment have been described.

### <Structure of Printhead>

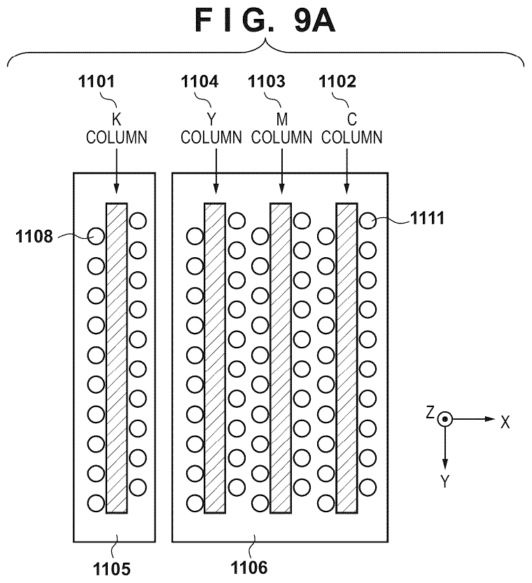

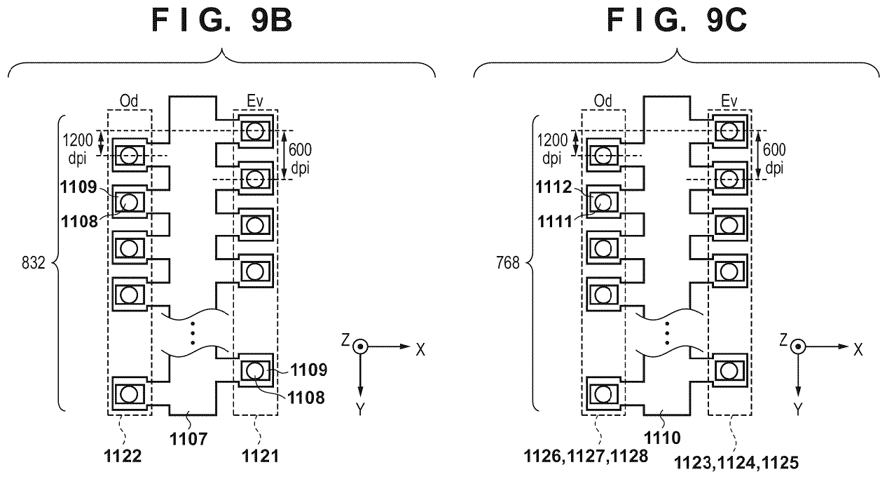

The structure of the printhead according to this embodiment will be described below with reference to FIGS. 9A to 9C. FIGS. 9A to 9C are schematic views of the printhead H used in this embodiment when viewed from the upper surface of the printing apparatus. The printhead H includes print chips 1105 and 1106, and each print chip receives a print signal from the main body of the printing apparatus via a contact pad (not shown), and is supplied with power necessary to drive the printhead. As shown in FIG. 9A, on the print chip 1105, a nozzle array 1101 (to be also referred to as a black nozzle array hereinafter) in which a plurality of nozzles for discharging black ink are arrayed in the Y direction is arranged. Similarly, on the print chip 1106, a nozzle array 1102 for discharging cyan ink, a nozzle array 1103 for discharging magenta ink, and a nozzle array 1104 for discharging yellow ink are arranged.

FIG. 9B is an enlarged view of the black nozzle array 1101. FIG. 9C is an enlarged view of one nozzle array among the nozzle arrays 1102, 1103, and 1104, that is, three nozzle arrays of cyan, magenta, and yellow in total. This enlarged view is common to color inks. Nozzles 1108 or 1111 for discharging ink are arranged on two sides of an ink liquid chamber 1107 or 1110. A discharge heater 1109 or 1112 is arranged immediately below each nozzle (on the +Z direction side). When the heater 1109 or 1112 is applied with a voltage, it generates heat to generate a bubble, thereby causing the corresponding nozzle to discharge ink. There are arranged 832 nozzles 1108 and 768 nozzles 1111. Each nozzle 1108 discharges black ink, and an Ev column 1121 (to be also referred to as an Ev nozzle array hereinafter) and an Od column 1122 (to be also referred to as an Od nozzle array hereinafter) each formed by arraying the nozzles 1108 at a pitch of 600 dpi in the Y direction are arranged. The Ev nozzle array is arranged by being shifted by a half pitch in the −Y direction with respect to the Od nozzle array. By performing print scanning using the black nozzle array 1101 having the above configuration, the print medium can be printed with a print density of 1,200 dpi. Similarly, the cyan nozzle array 1102, the magenta nozzle array 1103, and the yellow nozzle array 1104 are respectively obtained by arranging Ev columns 1123 to 1125 and Od columns 1126 to 1128 each formed by arraying the nozzles at a pitch of 600 dpi in the Y direction. The Ev column 1123 and the Od column 1126 correspond to the cyan nozzle array, the Ev column 1124 and the Od column 1127 correspond to the magenta nozzle array, and the Ev column 1125 and the Od column 1128 correspond to the yellow nozzle array. The Ev columns 1123 to 1125 are arranged by being shifted by a half pitch in the −Y direction with respect to the Od columns 1126 to 1128, respectively.

Note that the printhead H of this embodiment has a configuration including the print chip with the black nozzle array and the print chip with the cyan nozzle array, the magenta nozzle array, and the yellow nozzle array but the present disclosure is not limited to this configuration. More specifically, all the black nozzle array, the cyan nozzle array, the magenta nozzle array, and the yellow nozzle array may be mounted on one chip. Alternatively, a printhead on which a print chip with a black nozzle array is mounted may be separated from a printhead on which a print chip with a cyan nozzle array, a magenta nozzle array, and a yellow nozzle array is mounted. Alternatively, a black nozzle array, a cyan nozzle array, a magenta nozzle array, and a yellow nozzle array may be mounted on different printheads, respectively. Furthermore, the printhead H of this embodiment adopts a so-called bubble jet method of discharging ink by applying a voltage to a heater to generate heat but the present disclosure is not limited to this. More specifically, a configuration of discharging ink using electrostatic actuators or piezoelectric elements may be used. The contents of the structure of the printhead according to this embodiment have been described above.

### <Flight Characteristic of Main Droplet and Satellites Depending on Scanning Direction>

The printhead may have, in accordance with its structure, the flight characteristic, depending on the scanning direction, of a main droplet and satellites separated from an ink droplet. FIG. 11 is a view for explaining an example of the flight characteristic of a main droplet and satellites of ink discharged from a nozzle arrayed in the Ev nozzle array mounted on the printhead having the characteristic.

In FIG. 11, 11a shows a sectional view of a nozzle included in the Ev nozzle array, in which ink is supplied through a common ink channel on the left side in 11a from an ink tank storing ink. An ink droplet is discharged by the pressure of a bubble generated by heating a heating element 1501. At this time, there is a discharge characteristic that if flow resistance in the right direction in 11a is strong, asymmetry in the ink channel direction occurs to cause the meniscus shape or the shape of a bubble at the time of defoaming to be asymmetrical and tailing is bent to a far side from the ink channel on the left side.

In FIG. 11, 11b shows the flight characteristic of a main droplet and satellites of an ink droplet discharged from the nozzle described with reference to 11a of FIG. 11. Since tailing is bent to the opposite side of the ink channel on the left side in 11a of FIG. 11, the centers of satellite dots (to be also simply referred to as satellites hereinafter) 1503 and 1504 are deviated rightward in 11b with respect to the center of a main droplet 1502.

In FIG. 11, 11c shows a sectional view of a nozzle included in the Od nozzle array, in which ink is supplied through a common ink channel on the right side from an ink tank storing ink. An ink droplet is discharged by the pressure of a bubble generated by heating a heating element 1505. At this time, there is a discharge characteristic that if flow resistance in the left direction in 11c is strong, asymmetry in the ink channel direction occurs to cause the meniscus shape or the shape of a bubble at the time of defoaming to be asymmetrical and tailing is bent to a far side from the ink channel on the right side.

In FIG. 11, 11d shows the flight characteristic of a main droplet and satellites of an ink droplet discharged from the nozzle described with reference to 11c of FIG. 11. Since tailing is bent to the opposite side of the ink channel on the right side in 11c of FIG. 11, the centers of satellites 1507 and 1508 are deviated leftward in 11d with respect to the center of a main droplet 1506.

This embodiment assumes that the printhead H has the characteristic that an ink droplet flies, as shown in 11a to 11d of FIG. 11. Note that the flow resistance indicated by an arrow in 11a of FIG. 11 or 11c of FIG. 11 can be generated regardless of the scanning direction of the printhead H.

The characteristic that an ink droplet flies, which is different from that in 11a to 11d of FIG. 11, will be described below with reference to 11e to 11h of FIG. 11.

In FIG. 11, 11e shows a sectional view of the nozzle included in the Ev nozzle array, in which ink is supplied through the common ink channel on the left side from the ink tank storing ink. An ink droplet is discharged by the pressure of a bubble generated by heating the heating element 1501. At this time, there is a discharge characteristic that if flow resistance in the left direction in 11e is strong, asymmetry in the ink channel direction occurs to cause the meniscus shape or the shape of a bubble at the time of defoaming to be asymmetrical and tailing is bent in the ink channel direction on the left side.

In FIG. 11, 11f shows the flight characteristic of a main droplet and satellites of an ink droplet discharged from the nozzle described with reference to 11e of FIG. 11. Since tailing is bent in the ink channel direction on the left side in 11e of FIG. 11, the centers of the satellites 1503 and 1504 are deviated leftward in 11f with respect to the center of the main droplet 1502.

In FIG. 11, 11g shows a sectional view of the nozzle included in the Od nozzle array, in which ink is supplied through the common ink channel on the right side from the ink tank storing ink. An ink droplet is discharged by the pressure of a bubble generated by heating the heating element 1505. At this time, there is a discharge characteristic that if flow resistance in the right direction in 11g is strong, asymmetry in the ink channel direction occurs to cause the meniscus shape or the shape of a bubble at the time of defoaming to be asymmetrical and tailing is bent in the ink channel direction on the right side.

In FIG. 11, 11h shows the flight characteristic of a main droplet and satellites of an ink droplet discharged from the nozzle described with reference to 11g of FIG. 11. Since tailing is bent in the ink channel direction on the right side in 11g of FIG. 11, the centers of the satellites 1507 and 1508 are deviated rightward in 11g with respect to the center of the main droplet 1506.

The flight characteristic of the main droplet and satellites depending on the scanning direction of the printhead has been described above. As in this example, even if the flight characteristic is not the flight characteristic of the main droplet and the satellites in accordance with the scanning direction of the printhead, the flight distance of the main droplet may be different from the flight distance of the satellite between the first scanning direction and the second scanning direction as a scanning direction reverse to the first scanning direction. In addition, the present disclosure is not limited to the above-described difference in flight characteristic of the main droplet and the satellites caused by the nozzle structure. For example, the flight characteristic of the main droplet and the satellites may be different between a front nozzle array and a rear nozzle array in the advancing direction of the printhead H due to the influence of an air flow (not shown) generated by ink discharge and scanning of the printhead H. This embodiment assumes that the printhead H has the characteristic that an ink droplet flies, as shown in 11a to 11d of FIG. 11 described above.

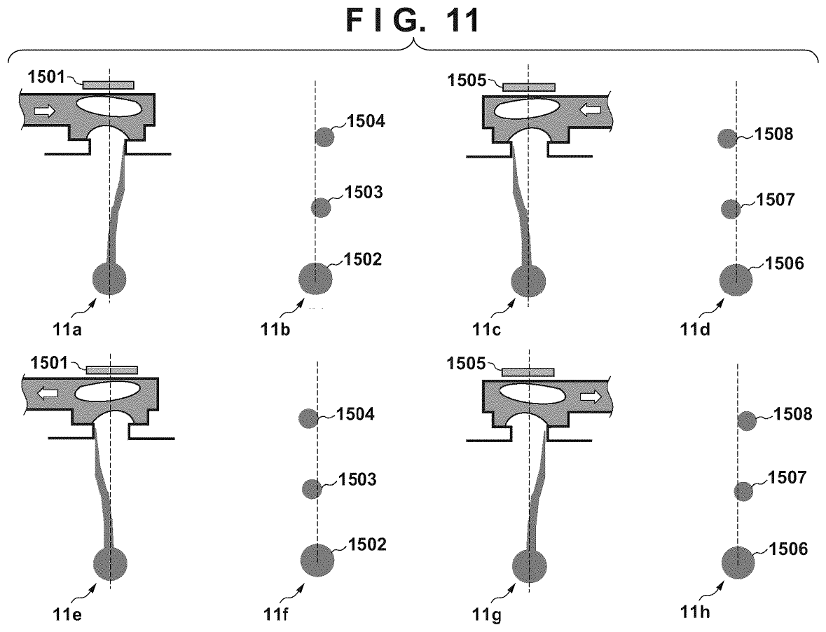

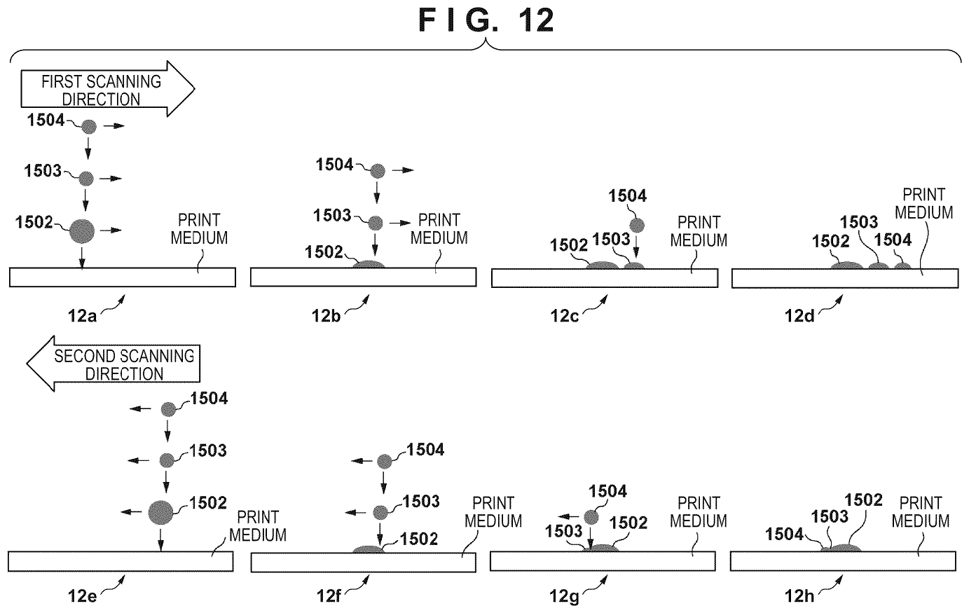

In FIGS. 12, 12a to 12h are views schematically showing a state in which when discharge from the nozzle of the Ev nozzle array has the flight characteristic of the main droplet and the satellites shown in 11b of FIG. 11, the main droplet 1502 and the satellites 1503 and 1504 land on the print medium in accordance with the scanning direction of the carriage. In 12a to 12h, an arrow indicating the horizontal direction represents a force applied in the scanning direction of the carriage, and an arrow in the downward direction represents a force applied by ink discharge. In the case of the first scanning direction in which the carriage advances rightward in 12a to 12d, the lapse of time until the main droplet and the satellites land is shown in time series in the order of 12a, 12b, 12c, and 12d of FIG. 12.

In 12a of FIG. 12, the center of the satellite 1503 exists on the front side of the center of the main droplet 1502 in the advancing direction, and the center of the satellite 1504 exists on the front side of the center of the satellite 1503 in the advancing direction. In 12b of FIG. 12, the main droplet 1502 lands on the print medium, and the satellites 1503 and 1504 continue flying. In 12c of FIG. 12, the satellite 1503 lands on a region not overlapping the ink application portion of the main droplet 1502, and the satellite 1504 continues flying. In 12d of FIG. 12, the satellite 1504 lands on a region not overlapping the ink application portions of the main droplet 1502 and the satellite 1503. As a result, the satellites 1503 and 1504 land at positions separated from the landing position of the main droplet 1502.

In the case of the second scanning direction in which the carriage advances leftward in 12e to 12 h, the lapse of time until the main droplet and the satellites land is shown in time series in the order of 12e, 12f, 12g, and 12h of FIG. 12. In 12e of FIG. 12, the center of the satellite 1503 exists on the rear side of the center of the main droplet 1502 in the advancing direction, and the center of the satellite 1504 exists on the rear side of the center of the satellite 1503 in the advancing direction. In 12f of FIG. 12, the main droplet 1502 lands on the print medium, and the satellites 1503 and 1504 continue flying. In 12g of FIG. 12, the satellite 1503 lands on a region overlapping the ink application portion of the main droplet 1502, and the satellite 1504 continues flying. In 12h of FIG. 12, the satellite 1504 lands on a region overlapping the ink application portion of the main droplet 1502 or the satellite 1503. As a result, the satellites 1503 and 1504 land at positions close to the landing position of the main droplet 1502.

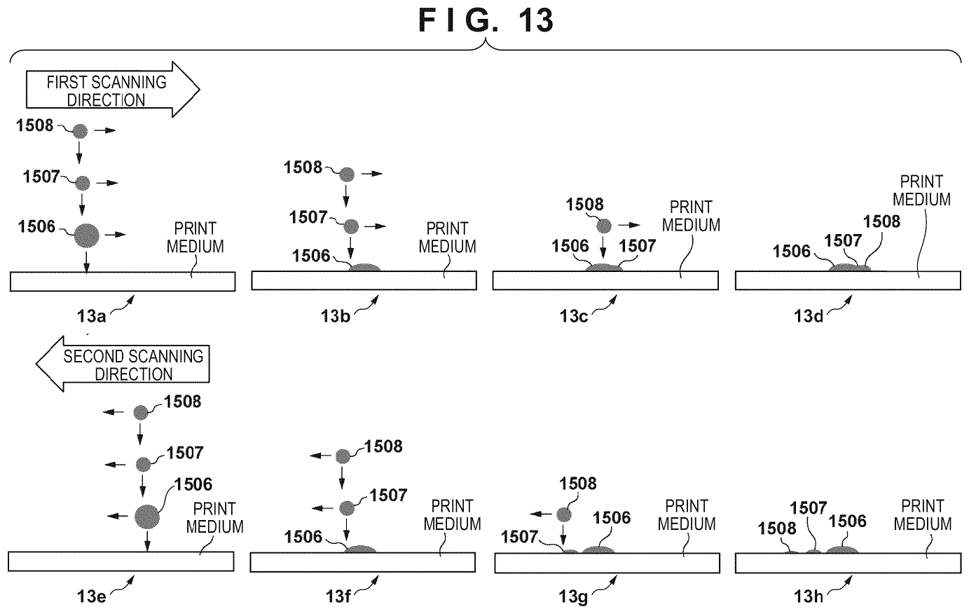

In FIGS. 13, 13a to 13h are views schematically showing a state in which when discharge from the nozzle of the Od nozzle array has the flight characteristic of the main droplet and the satellites shown in 11d of FIG. 11, the main droplet 1506 and the satellites 1507 and 1508 land on the print medium in accordance with the scanning direction of the carriage. In 13a to 13h, an arrow indicating the horizontal direction represents a force applied in the scanning direction of the carriage, and an arrow in the downward direction represents a force applied by ink discharge. In the case of the first scanning direction in which the carriage advances rightward in 13a to 13d, the lapse of time until the main droplet and the satellites land is shown in time series in the order of 13a, 13b, 13c, and 13d of FIG. 13.

In 13a of FIG. 13, the center of the satellite 1507 exists on the rear side of the center of the main droplet 1506 in the advancing direction, and the center of the satellite 1508 exists on the rear side of the center of the satellite 1507 in the advancing direction. In 13b of FIG. 13, the main droplet 1506 lands on the print medium, and the satellites 1507 and 1508 continue flying. In 13c of FIG. 13, the satellite 1507 lands on a region overlapping the ink application portion of the main droplet 1506, and the satellite 1508 continues flying. In 13d of FIG. 13, the satellite 1508 lands on a region overlapping the ink application portion of the main droplet 1506 or the satellite 1507. As a result, the satellites 1507 and 1508 land at positions close to the landing position of the main droplet 1506.

In the case of the second scanning direction in which the carriage advances leftward in 13e to 13 h, the lapse of time until the main droplet and the satellites land is shown in time series in the order of 13e, 13f, 13g, and 13h of FIG. 13. In 13e of FIG. 13, the center of the satellite 1507 exists on the front side of the center of the main droplet 1506 in the advancing direction, and the center of the satellite 1508 exists on the front side of the center of the satellite 1507 in the advancing direction. In 13f of FIG. 13, the main droplet 1506 lands on the print medium, and the satellites 1507 and 1508 continue flying. In 13g of FIG. 13, the satellite 1507 lands on a region not overlapping the ink application portion of the main droplet 1506, and the satellite 1508 continues flying. In 13h of FIG. 13, the satellite 1508 lands on a region not overlapping the ink application portions of the main droplet 1506 and the satellite 1507. As a result, the satellites 1507 and 1508 land at positions separated from the landing position of the main droplet 1506.

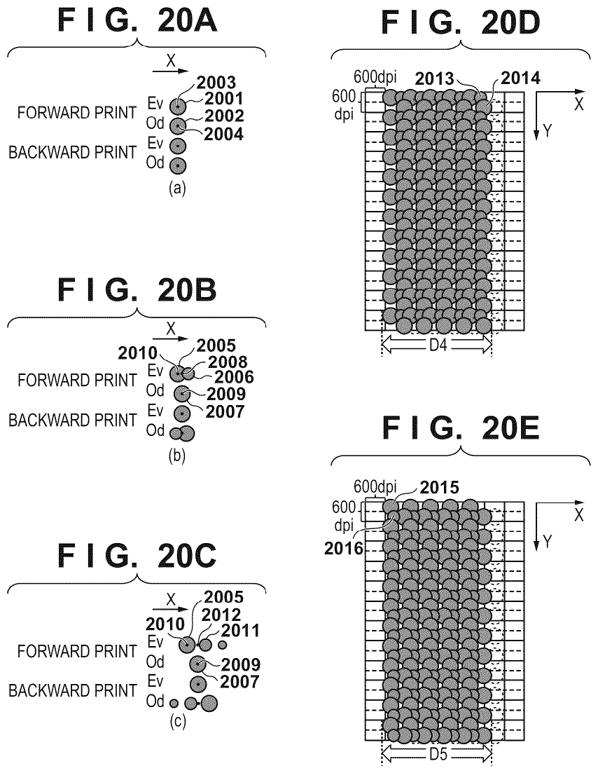

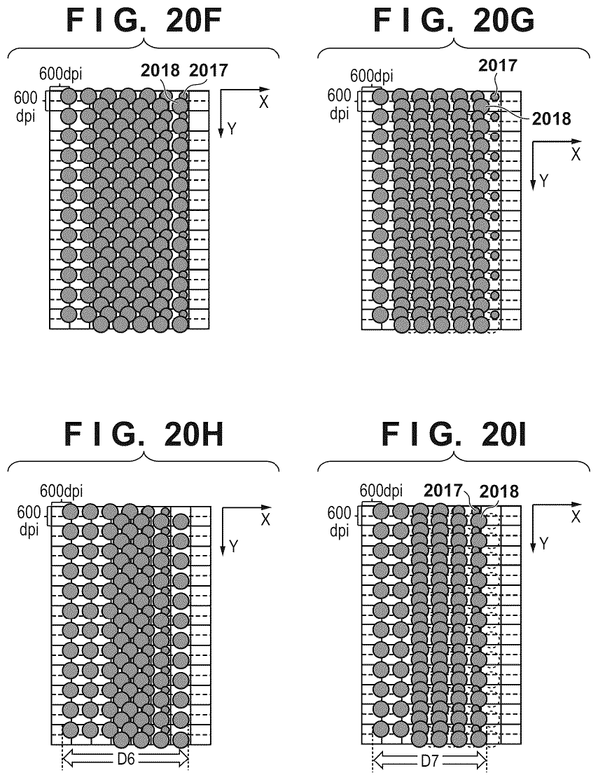

The flight characteristic of the main droplet and the satellites depending on the scanning direction of the carriage and the landing positions of the main droplet and the satellites on the print medium have been described above. The characteristic described with reference to 11a to 11d of FIG. 11, FIG. 12, and FIG. 13 will be referred to as the “first flight characteristic” hereinafter. On the other hand, the printhead may have, in accordance with its structure, the characteristic that the positional relationship between the main droplet and the satellites on the print medium is substantially the same regardless of the scanning direction and the nozzle array, and this characteristic will be referred to as the “second flight characteristic” hereinafter. For the sake of simplicity, this embodiment assumes that the printhead having the second flight characteristic is a printhead for causing a satellite not to land on the print medium or to land at the same position as that of a main droplet 2001 or 2002, as shown in FIG. 20A.

### <Configuration of Printing System>

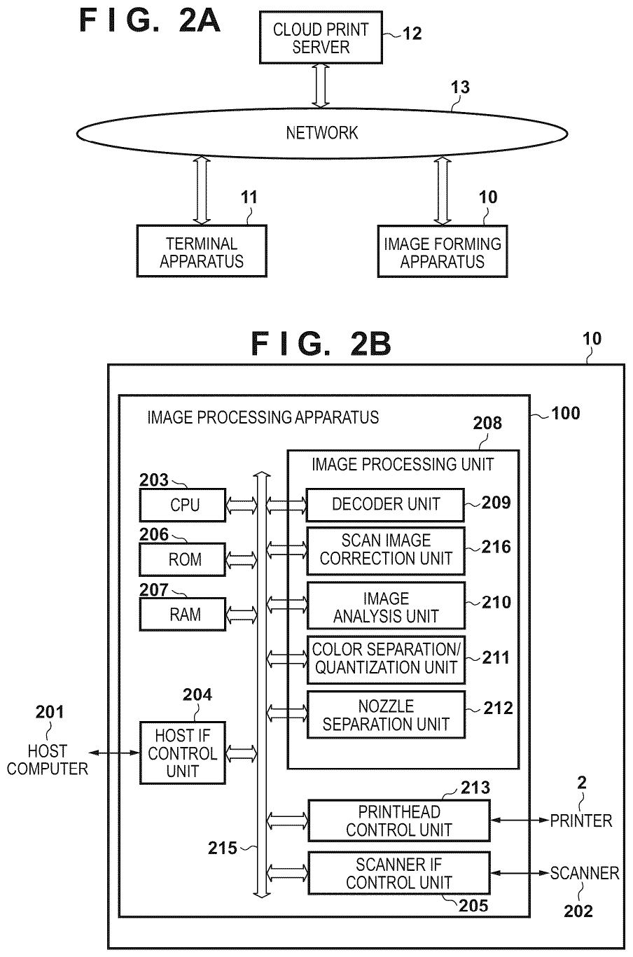

FIG. 2A is a view showing an example of the configuration of a printing system including an image forming apparatus 10 on which the printing apparatus 2 is mounted. As an example, FIG. 2A shows a cloud print system in which a terminal apparatus 11, a cloud print server 12, and the image forming apparatus 10 are connected via a network 13. The cloud print server 12 is a server apparatus that provides a cloud print service. That is, in the configuration shown in FIG. 2A, the image forming apparatus 10 is a printer supporting cloud printing. The network 13 is a wired network, a wireless network, or a network including both of them. As the network 13, for example, an Internet, WAN, or VPN environment is assumed. However, the printing system is not limited to the cloud print system. For example, the network 13 may be formed as an office LAN or the terminal apparatus 11 and the image forming apparatus 10 may directly be connected without intervention of the network 13. FIG. 2A shows one terminal apparatus 11 and one image forming apparatus 10 but a plurality of terminal apparatuses 11 and a plurality of image forming apparatuses 10 may be provided. The cloud print server 12 may be a server system formed by a plurality of information processing apparatuses. The printing system may be a cloud print system in which a plurality of cloud print services cooperate with each other.

The terminal apparatus 11 is an information processing apparatus such as a PC, a tablet, or a smartphone, and a cloud printer driver for a cloud print service is installed in the terminal apparatus 11. A user can execute arbitrary application software on the terminal apparatus 11. For example, a print job and print data are generated via the cloud printer driver based on image data generated on the print application. The print job and the print data are transmitted, via the cloud print server 12, to the image forming apparatus 10 registered in the cloud print service. The image forming apparatus 10 is a device that executes printing on a print medium such as a sheet, and prints an image on the print medium based on the received print data.

### <Configuration of Control System>

The configuration of a control system according to this embodiment will be described below with reference to FIG. 2B. FIG. 2B is a schematic block diagram of an image processing apparatus 100. This embodiment assumes that the image processing apparatus 100 is included in the image forming apparatus 10. However, the image processing apparatus 100 may be formed as an apparatus connected to the image forming apparatus 10 including the printer 2 and a scanner 202. For example, the image processing apparatus 100 may be formed in a host computer 201. In this case, the image processing apparatus 100 need not include a printhead control unit 213 or a scanner IF control unit 205.

The host computer 201 is an information processing apparatus that, for example, creates a print job formed from input image data and print condition information necessary for printing, and corresponds to, for example, the terminal apparatus 11 shown in FIG. 2A. Note that the print condition information is information concerning the type and size of a print sheet, print quality, and the like.

The scanner 202 is a scanner device connected to the image processing apparatus 100, and converts analog data, generated by optically reading a document placed on a scanner table, into digital data via an A/D converter. Reading by the scanner 202 is executed when the host computer 201 transmits a scan job to the image processing apparatus 100 but the present disclosure is not limited to this. A dedicated UI apparatus connected to the scanner 202 or the image processing apparatus 100 can substitute for the scanner 202.

A ROM 206 is a readable memory that stores a program for controlling the image processing apparatus 100. A CPU 203 controls the image processing apparatus 100 by executing the program stored in the ROM 206. A host IF control unit 204 communicates with the host computer 201, receives a print job or the like, and stores the print job in a RAM 207. The RAM 207 is a readable/writable memory used as a program execution area or a data storage area.

An image processing unit 208 generates printable nozzle data separated for each nozzle from input image data stored in the RAM 207 in accordance with a print condition included in a print job. The generated nozzle data is stored in the RAM 207. The image processing unit 208 includes a decoder unit 209, a scan image correction unit 216, an image analysis unit 210, a color separation/quantization unit 211, and a nozzle separation processing unit 212.

The printhead control unit 213 generates print data based on the nozzle data stored in the RAM 207, and controls the printhead H within the printer 2. Furthermore, the printhead control unit 213 sets, in the nozzle arrays 1121 to 1128, a plurality of discharge position adjustment values stored in the RAM 207, thereby controlling the discharge positions of the nozzles included in the nozzle arrays 1121 to 1128 in main scanning of the printhead H. The discharge positions are controlled using an encoder strip (not shown) mounted on the printing apparatus 2. A shared bus 215 is connected to each of the CPU 203, the host IF control unit 204, the scanner IF control unit 205, the ROM 206, the RAM 207, and the image processing unit 208. These connected units can communicate with each other via the shared bus 215. The contents of the configuration of the control system according to this embodiment have been described above.

### <Overall Procedure>

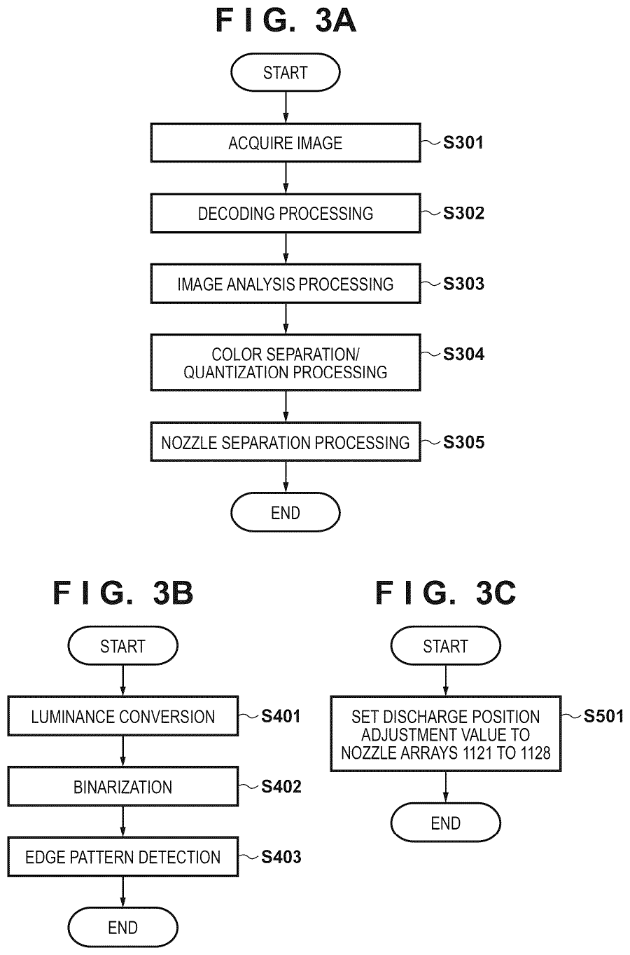

The procedure of edge processing, discharge position adjustment, and image printing according to this embodiment will be described below. The edge processing is processing including processing of detecting edge pixels located in the boundary between an object and the outside of the object. FIG. 3A is flowchart illustrating processing executed by the image processing unit 208 according to this embodiment. In this embodiment, with the processing shown in FIG. 3A, input image data can be converted into nozzle data. The processing shown in FIG. 3A is executed by the image processing unit 208 but the image processing unit 208 may operate under the control of the CPU 203. In this case, in other words, the processing shown in FIG. 3A is executed by the CPU 203.

In step S301, the image processing unit 208 acquires input image data from the RAM 207. In step S302, the decoder unit 209 performs decoding processing of the acquired input image data. The saving format of the input image data varies, and a compression format such as JPEG is generally used to decrease a communication amount between the host computer 201 and the image processing apparatus 100. In a case where the saving format is JPEG, the decoder unit 209 decodes JPEG and converts it into a bitmap format (an information format that records an image as continuous pixel values). In a case where the host computer 201 communicates with the image processing apparatus 100 via a dedicated driver or the like, a dedicated saving format may be handled. In a case where a dedicated saving format convenient for both the driver and the image processing apparatus 100 is held, the decoder unit 209 can perform conversion into the dedicated saving format. In accordance with, for example, the characteristic of an inkjet printing apparatus, saving formats with different compression ratios can be applied to a region where information is desirably held at fine accuracy and other regions. If it is desirable to focus on image quality instead of decreasing the communication amount, the input image data may be in the bitmap format. In this case, the decoder unit 209 need only output the bitmap format intact as a conversion result.

In step S303, the image analysis unit 210 executes image analysis using the bitmap image as a decoding result. In this embodiment, by executing image analysis, it is estimated based on a feature in the image whether a target pixel is paper white or in an end portion with a pixel formed by ink different from the target pixel. In addition, an end portion, where the target pixel exists, in a specific direction among the upper, lower, left, and right directions in a shape formed by a pixel group is estimated.

FIG. 3B shows the internal processing procedure of the image analysis processing executed in step S303. In step S401, the image analysis unit 210 converts the bitmap image as a decoding result into luminance values. For example, if the bitmap image data is information of three channels of R, G, and B, the bitmap image data is converted into one channel of luminance Y. Note that if the image data transmitted from the user by the application is already represented by a luminance, step S401 need not be executed.

In step S402, the image analysis unit 210 converts data of the luminance Y into binary data for edge detection. In this embodiment, as an example, by using threshold data Th provided in advance in correspondence with a print mode of the printer, the image analysis unit 210 converts the data into binary data (Bin) by conditional expression (1) below. The binary data generation expression is merely an example, and the design of an inequality condition and the form of an expression are not limited to this.

IF Y>Th:Bin=0 else: Bin=1 (1)

In this embodiment, image analysis is executed using an index of a luminance. In the inkjet printing apparatus, a tone at which black ink is used in color separation is limited. This is because the paper surface density of black ink largely changes for each drop with respect to paper white, and thus image quality readily deteriorates in terms of graininess by frequently using black ink from a low tone. Therefore, it is easy to determine the generation position of black ink based on the luminance information of the input image, as compared with other color inks. By setting the above threshold data Th to an appropriate value, it is possible to set, in the luminance information, a luminance value corresponding to a tone from which black ink is ejected by a predetermined amount or more after ink separation. In this embodiment, it is possible to control the number and arrangement of dots of black ink and the number and arrangement of dots of other color inks adjacent to black ink, and the use of the luminance value is under the control. However, this embodiment is not limited to this. For example, color separation may be executed in advance for the analysis processing and a pixel where black ink is generated as a predetermined color component may correctly be grasped. If color separation is executed in advance, pixels where cyan, magenta, and yellow inks are generated in addition to black ink and discharge amounts of the inks can be grasped, thereby making it possible to perform more detailed analysis. The input image data may be in the CMYK format or the like instead of the RGB format, and may include information effective for analysis when it is the input image data. If the discharge amounts of cyan, magenta, and yellow inks are known, when the discharge amounts are small, color may be considered equivalent to paper white, and determination such as analysis of black ink generated in a region corresponding to paper white on the paper surface may be executed. In this embodiment, the determination is expressed by the threshold data Th. The threshold data Th may appropriately be updated in accordance with the degree of consumption of each nozzle of the nozzle arrays 1101 to 1104 of the printhead in the printing apparatus.

In step S403, the image analysis unit 210 executes edge pattern detection using the binary data.

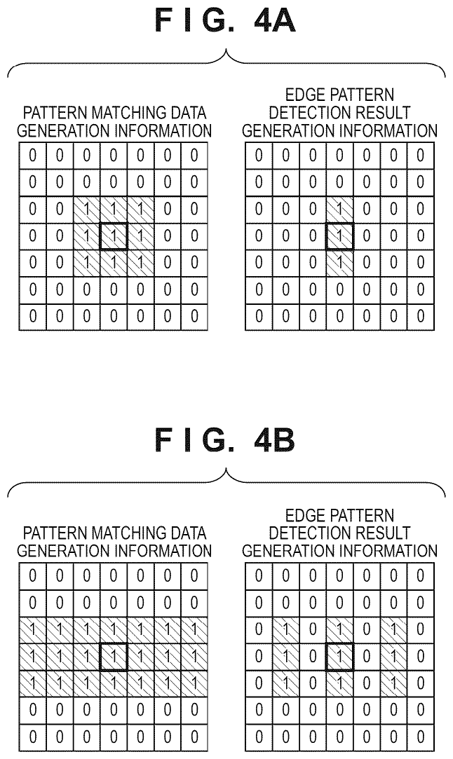

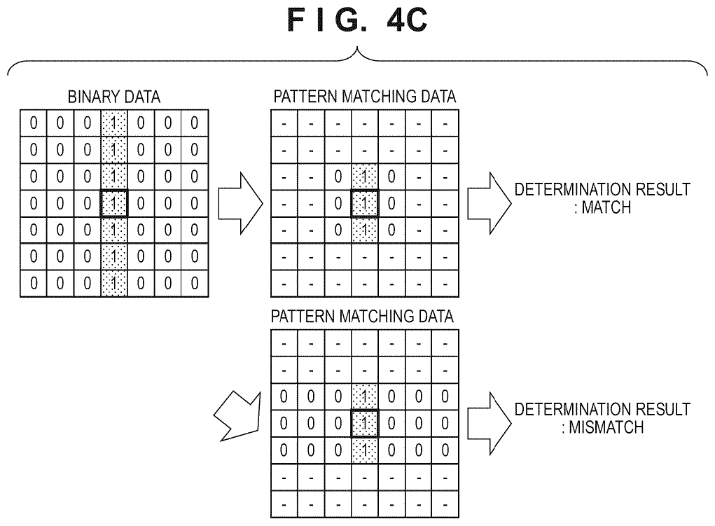

FIGS. 4A and 4B each show an example of pattern information for edge pattern detection. The pattern information includes two types of information, that is, “pattern matching data generation information” and “edge pattern detection result generation information”. The pattern matching data generation information is obtained by executing bit AND processing for each pixel in a rectangular region of the binary data obtained in step S402. Pattern matching data obtained as a result of the bit AND processing is obtained by extracting only information necessary to detect an edge pattern from the rectangular region. The edge pattern detection result generation information is information for executing pattern matching processing for the pattern matching data. If a complete match is obtained as a result of the pattern matching processing, the rectangular region is determined as a predetermined edge pattern. The determination result is linked with the central pixel in the rectangular region.

FIG. 4A shows pattern information for determining that a target pixel is “in a left/right end portion of a 1-dot vertical line”. The pattern matching data generation information is set with values so as to perform edge pattern detection for 3×3 pixels including the target pixel. A pixel added with “0” in the pattern matching data generation information is regarded as a pixel that is not considered in pattern matching regardless of how the binary data is formed. Next, the edge pattern detection result generation information corresponds to the above-described predetermined edge pattern, and is, in this example, a pattern in which only three pixels in a central vertical column among the 3×3 pixels are set with 1. This information corresponds to determination of whether the three pixels in the central vertical column have low luminance and the remaining six pixels have high luminance. If pattern matching data completely matches this pattern, it is found that there exists a high-luminance characteristic=paper white or low-density color ink at least on the left and right sides and there exists a low-luminance characteristic=black ink in the target pixel and the upper and lower pixels thereof.

FIG. 4B shows pattern information for determining that the target pixel is not only “in the left/right end portion of a 1-dot vertical line” but also “in a part of 1 dot/1 space”. 1 dot/1 space indicates a pattern in which a plurality of 1-dot vertical lines are arranged at an interval of 1 dot. By widening the range of the pattern matching data generation information to 7×3 pixels, information concerning the periphery of the 1-dot line to which the target pixel belongs can be included for determination.

FIG. 4C shows a result of successively performing pattern matching for the binary data using FIG. 4A or 4B. When applying the pattern matching data generation information and the edge pattern detection result generation information shown in FIG. 4A to the target binary data, a determination result is determined as “match”. When applying the pattern matching data generation information and the edge pattern detection result generation information shown in FIG. 4B to the target binary data, a determination result is determined as “mismatch”. Based on the two pattern detection results, it is found that the target binary data is “in the left/right end portion of a 1-dot vertical line” but “not in a part of 1 dot/1 space”.

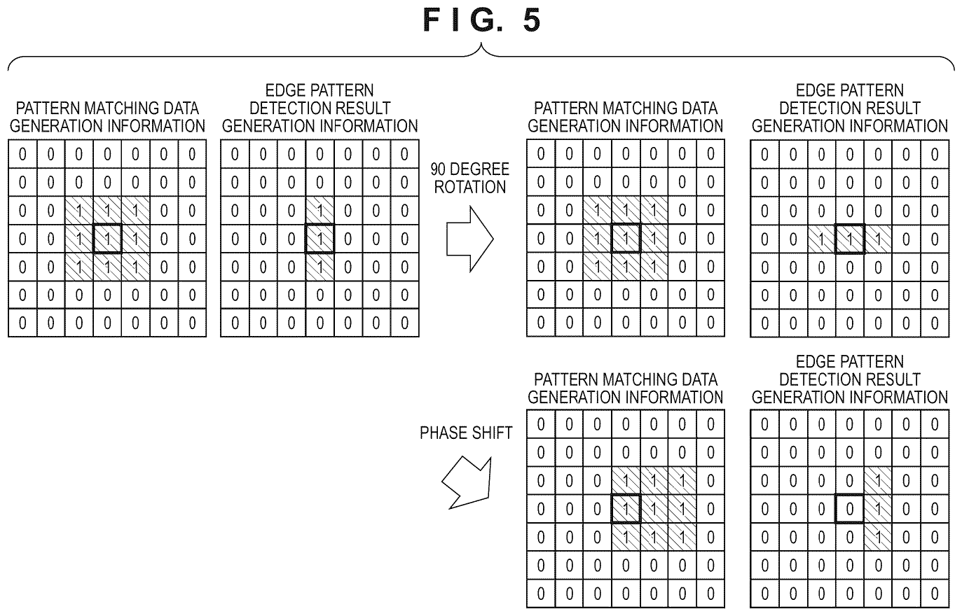

Based on the above-described method, it is possible to detect various edge patterns. In this embodiment, 7×7 pixels are set as the target of pattern matching, but this is merely an example. If, for example, it is only necessary to be able to detect the pattern shown in FIG. 4A or 4B, 7×3 pixels suffice as the target of pattern matching. On the other hand, if it is desirable to individually detect a line shape of a 4- or more-dot line, 7×7 pixels are insufficient and a wider region may be set as a target. By widening the target range, a work memory for holding binary data to be compared and a work memory for holding pattern matching information are required more. The work memory corresponds to the RAM 207. In a case where the image analysis unit 210 is implemented as a dedicated circuit, when it is desirable to process a plurality of pixels by performing pattern matching by a parallel clock, the numbers of processing registers and processing circuits increase. Furthermore, since it is necessary to hold in advance the pattern matching information in the ROM 206 of the image processing apparatus 100, the capacity of the ROM 206 is also required. If the edge pattern is finely and diversely confirmed, more pattern matching information needs to be held, and thus it is necessary to perform design in consideration of the memory capacity and an increase in analysis time caused by an increase in number of times of comparison. Making determination of “0” in the pattern matching data generation information=“not considered in pattern matching” contributes to a decrease in memory capacity and a decrease in number of times of comparison. As another configuration for decreasing the memory capacity, as shown in FIG. 5, it is also possible to perform pattern matching of another variation by processing such as rotation or phase shifting. On the upper side of FIG. 5, the pattern matching information shown in FIG. 4A is rotated by 90°, and it is possible to determine that the target pixel is “in the upper/lower end portion of a 1-dot horizontal line” using the processed pattern information. On the lower side of FIG. 5, the pattern information shown in FIG. 4A is horizontally shifted by 1 pixel, and it is possible to determine that the target pixel is “an adjacent pixel of a 1-dot vertical line” using the processed pattern matching information. In FIG. 5, variations are increased by processing the pattern matching information. However, variations can be increased by processing the binary data.

As shown in FIG. 4C, it is effective to narrow a determination result by successively applying a plurality of pieces of pattern matching information and to obtain information that is not known by individual pattern matching information. For example, when “match” with the pattern shown in FIG. 4A is determined in FIG. 4C, it may be unnecessary to perform determination with respect to a 2- or more-dot line prepared in advance. An effect of decreasing the number of times of comparison is obtained by applying only the pattern matching information for determining more detailed information of the 1-dot line, as shown in FIG. 4B. By applying FIG. 4A or 4B, it is found that the target binary data is “in the left-right end portion of a 1-dot vertical line” and “not in a part of 1 dot/1 space”. Not by preparing obtainable individual pattern matching information but by deriving that information from the results of FIGS. 4A and 4B, an effect of reducing the memory capacity is obtained.

As described above, in this embodiment, it is possible to determine whether the target pixel is a pixel to undergo special processing such as processing of thinning dots or processing of changing the arrangement of dots.

The determination result of the image analysis processing in step S303 is output in an information format suitable for processing in a subsequent step. For example, the determination result can be expressed by 3-bit multi-valued data such as non-detection (non-appropriate for any detection pattern)=0, upper end portion detection=1, lower end portion detection=2, left end portion detection=3, right end portion detection=4, and adjacent to one of end portions=5. Alternatively, expression of assignment of each bit within 5 bits is also possible, such as non-detection=00000, upper end portion detection=00001, lower end portion detection=00010, left end portion detection=00100, right end portion detection=01000, and adjacent to one of end portions=10000. The former can transmit the determination result to the next processing with a small data amount. The latter has a merit of reducing the processing load since bit processing can be used in the next processing. It has been explained that the five pieces of information are transmitted to the subsequent step. However, as described in step S303 that “the pattern matching information can be diversely expressed”, information more than control information necessary for the subsequent processing steps may be detected and transmitted.

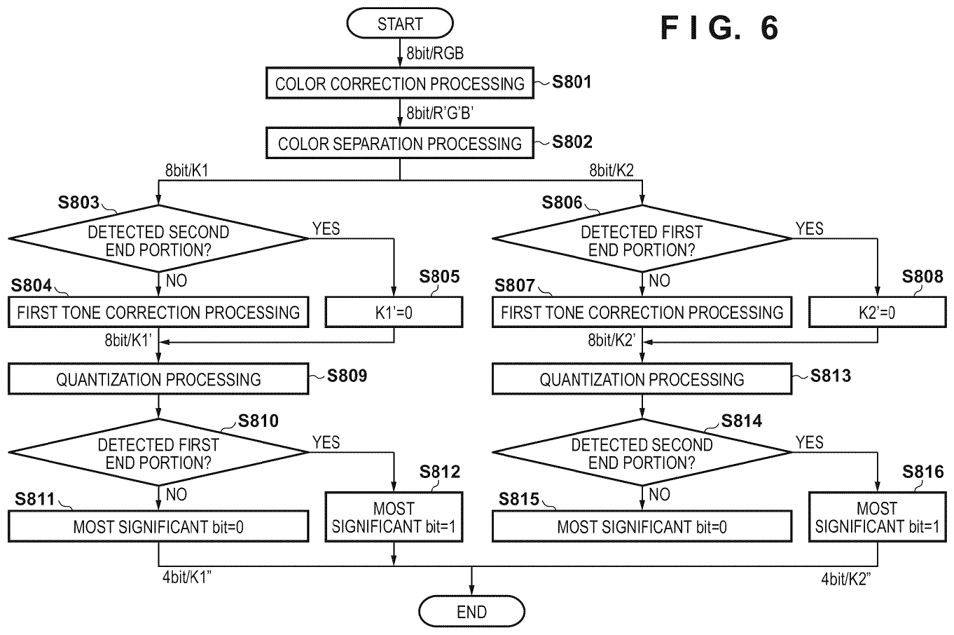

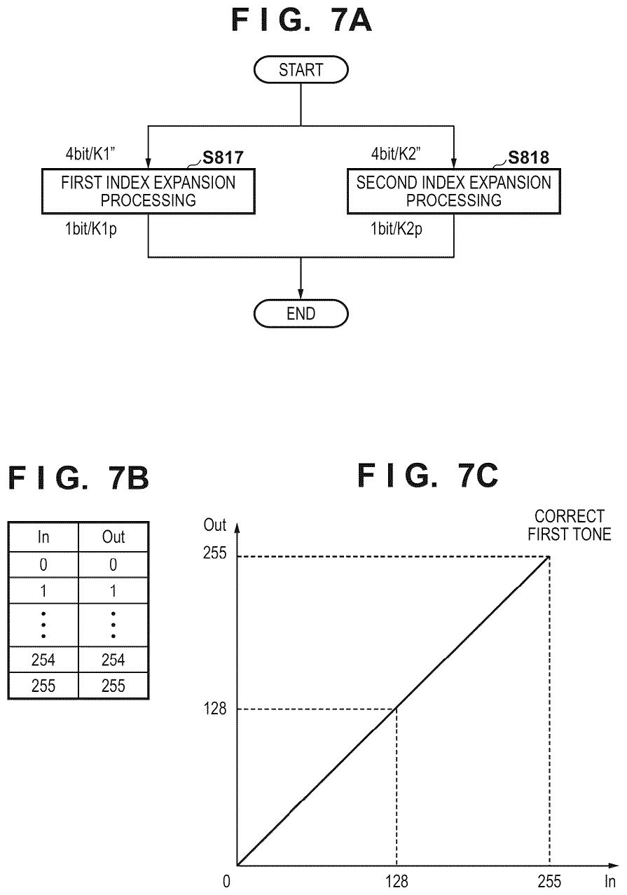

FIGS. 6 and 7A show an example of the internal processing procedure of color separation/quantization processing executed in step S304 and nozzle separation processing executed in step S305. Note that the following description assumes that the bitmap image as the decoding result of step S302 includes pixels that are arrayed at 600 dpi and each of which has an 8-bit, 256-level luminance value for each of R (red), G (green), and B (blue). In the end portion information detected in step S303, the upper end portion (first end portion), the lower end portion (second end portion), the right end portion (fourth end portion), and the left end portion (third end portion) are defined as pixels that change from 1 to 0 in Bin in the −Y direction, the +Y direction, the +X direction, and the −X direction, respectively, and are on the side of Bin=1. Since nozzles of each color of the printhead H are arranged at 1,200 dpi in the Y direction, each pixel is printed using a nozzle (to be referred to as an Ev nozzle hereinafter) of the Ev column and a nozzle (to be referred to as an Od nozzle hereinafter) of the Od column. At this time, the nozzle located on the upper end side of each pixel is defined as an upstream side nozzle, and the nozzle located on the lower end side of each pixel is defined as a downstream side nozzle. In this embodiment, assume that the upstream side nozzle corresponds to the Ev nozzle and the downstream side nozzle corresponds to the Od nozzle. That is, in this embodiment, the configuration has a print resolution that is twice, in the Y direction, the resolution of the image data to undergo edge pattern detection.

In color correction processing in step S801, the color separation/quantization unit 211 converts RGB data of each pixel into R′G′B′ data expressed in a color space unique to the printing apparatus. As a detailed conversion method, for example, conversion can be performed by referring to a lookup table stored in advance in the memory.

In step S802, the color separation/quantization unit 211 performs color separation processing for the R′G′B′ data. More specifically, with reference to a lookup table stored in advance in the memory, the luminance values R′, G′, and B′ of each pixel are converted into 8-bit, 256-level density values C, M, Y, and K corresponding to ink colors used by the printing apparatus. Furthermore, the color separation/quantization unit 211 copies the density value data of one or more colors of C, M, Y, and K, thereby generating two coincident data in total. For the sake of simplicity, an example of generating black data K1 and K2 will be described. Note that K1 and K2 are adopted to the Ev nozzles and the Od nozzles of the black nozzle array 1101, respectively, by processing (to be described later).

In steps S803 to S805, the color separation/quantization unit 211 performs different tone correction processing based on whether the processed pixel is in the second end portion using the density value K1 and the result determined in step S303. In steps S806 to S808, the color separation/quantization unit 211 performs different tone correction processing based on whether the processed pixel is in the first end portion using the density value K2 and the result determined in step S303. The tone correction processing is such correction that the input density value and an optical density expressed by the print medium P have a linear relationship. This correction processing converts the 8-bit, 256-level density values K1 and K2 into 8-bit, 256-level density values K1′ and K2′. If it is detected in step S303 that the pixel is in the second end portion, the density value K1 is converted into K1′=0 in step S805; otherwise, the density value K1 is converted into K1′ by the first tone correction processing in step S804. On the other hand, if it is detected in step S303 that the pixel is in the first end portion, the density value K2 is converted into K2′=0 in step S808; otherwise, the density value K2 is converted into K2′ by the first tone correction processing in step S807. FIGS. 7B and 7C are a table and a graph showing an example of setting of the first tone correction processing, in which In corresponds to the density values K1 and K2 and Out corresponds to the density values K1′ and K2′. In this description, for the sake of simplicity, an example in which In and Out have a linear relationship is shown.

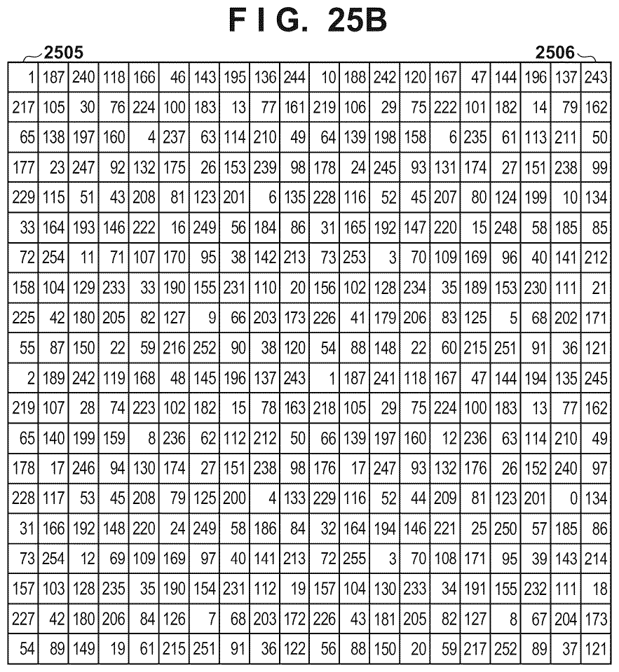

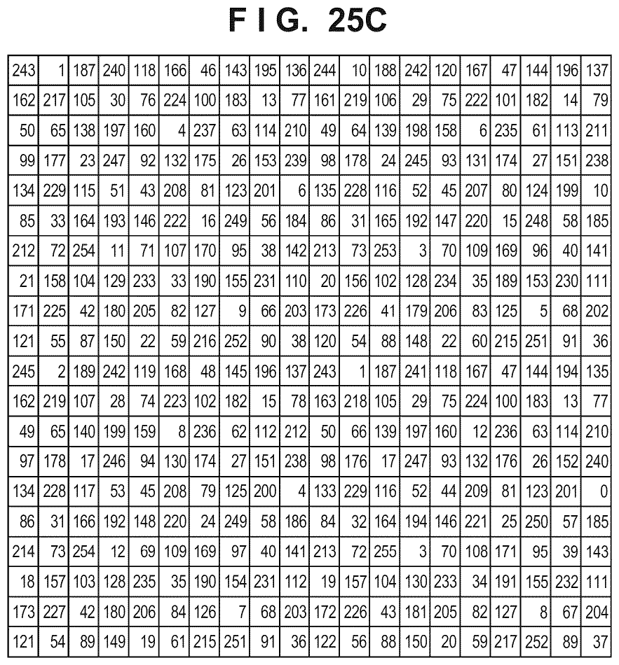

In step S809, the color separation/quantization unit 211 performs, using an arbitrary quantization table as shown in FIG. 25B, quantization processing for the density value K1′ to convert it into 4-bit 3-valued quantization data (quantization value) of “0000”, “0001”, and “0010”. Detailed processing in conversion is as follows. The color separation/quantization unit 211 doubles the density value K1′, and divides the thus obtained value by 255 as the maximum value of values in the quantization table, thereby calculating a quotient Q and a remainder E for each pixel. At this time, Q can take 0, 1, or 2, and E can take 0 to 254. Note that E=0 is obtained for Q=2. Then, the remainder E of each pixel is compared with a value D of a cell in the quantization table, which corresponds to the pixel. As a result, if “Q=2” or “Q=1 and E>D”, the quantization data is “0010”. If “Q=1 and E≤D” or “Q=0 and E>D”, the quantization data is “0001”. If “Q=0 and E≤D”, the quantization data is “0000”. With the above processing, the 3-valued quantization data is generated. Note that in a case where the size of the quantization table is smaller than that of the input image, the table is repeatedly applied in the X and Y directions of the input image. In this example, three values of a low density, an intermediate density, and a high density are expressed. Furthermore, in steps S810 to S812, the color separation/quantization unit 211 sets a value in the most significant bit based on whether the processed pixel is in the first end portion using the result determined in step S303, and outputs 4-bit quantization data K1″. More specifically, if it is detected that the pixel is in the first end portion, the most significant bit=1 is set in step S812; otherwise, the most significant bit=0 is set in step S811. Similarly, in step S813, the color separation/quantization unit 211 performs, using an arbitrary quantization table, quantization processing for the density value K2′ to convert it into 4-bit 3-valued quantization data of “0000”, “0001”, and “0010”. In this example, three values of a low density, an intermediate density, and a high density are expressed. Furthermore, in steps S814 to S816, the color separation/quantization unit 211 sets a value in the most significant bit based on whether the processed pixel is in the second end portion using the result determined in step S303, and outputs 4-bit quantization data K2″. More specifically, if it is detected that the pixel is in the second end portion, the most significant bit=1 is set in step S816; otherwise, the most significant bit=0 is set in step S815.

In step S305, the nozzle separation processing unit 212 performs index expansion processing for the quantization data K1″ and K2″ output in step S304. In the index expansion processing of this embodiment, the quantization data K1″ and K2″ of 600×600 dpi are converted into binary nozzle data K1p and K2p of 600×600 dpi using an index pattern prepared in advance. The quantization data K1″ is converted into the nozzle data K1p by the first index expansion processing in step S817 of FIG. 7A, and the quantization data K2″ is converted into the nozzle data K2p by the second index expansion processing in step S818. In other words, the index pattern is a dot arrangement pattern for arranging dots in pixels.

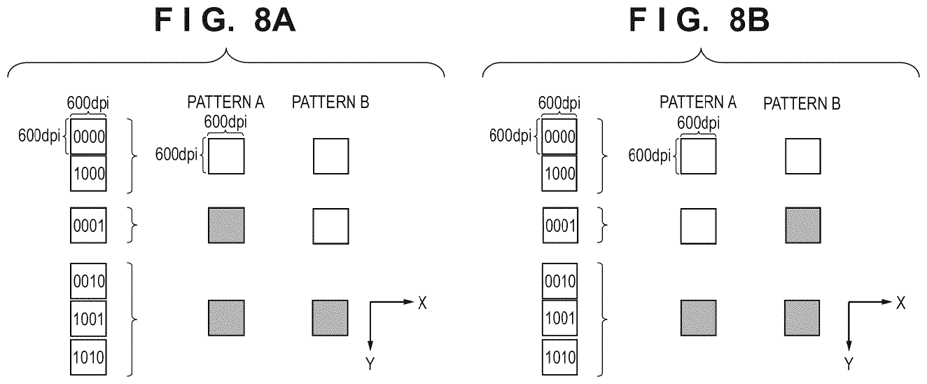

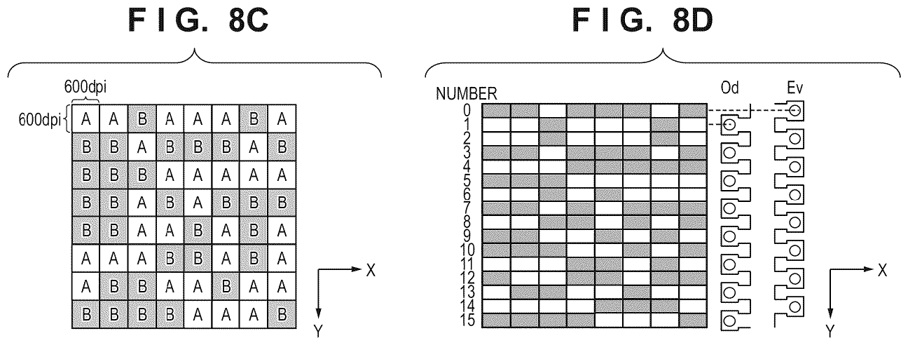

FIGS. 8A to 8D are views showing examples of the dot arrangement pattern used in the index expansion processing and a reference index pattern. FIG. 8A is a view showing the dot arrangement pattern of the first index expansion processing. If the quantization data K1″ of one pixel of 600 dpi×600 dpi indicates “0000” or “1000”, no dot is surely arranged in this pixel. If the quantization data K1″ indicates “0001”, pattern A in which a dot is arranged and pattern B in which no dot is arranged are prepared. If the quantization data K1″ indicates “0010”, “1001”, or “1010”, a dot is surely arranged in the pixel. FIG. 8B is a view showing the dot arrangement pattern of the second index expansion processing. If the quantization data K2″ of one pixel of 600 dpi×600 dpi indicates “0001”, pattern A in which no dot is arranged and pattern B in which a dot is arranged are prepared. If the quantization data K2″ indicates “0000”, “1000”, “0010”, “1001”, or “1010”, the same processing as that in the first index expansion processing is performed. FIG. 8C is a view showing an example of the reference index pattern. In this embodiment, different index patterns are respectively used in the first index expansion processing in step S817 and the second index expansion processing in step S818 but each pattern is created with reference to the reference index pattern shown in FIG. 8C. In the reference index pattern, each rectangle corresponds to one pixel region of 600 dpi×600 dpi, and it is determined, for each pixel, which of patterns A and B is used to arrange a dot. The nozzle separation processing unit 212 generates, as data for the Ev nozzle of the black nozzle array 1101 corresponding to each pixel, the nozzle data K1p of each pixel after the first index expansion processing, and stores the data in the RAM 207. Furthermore, the nozzle separation processing unit 212 generates, as data for the Od nozzle of the black nozzle array 1101 corresponding to each pixel, the nozzle data K2p of each pixel after the second index expansion processing, and stores the data in the RAM 207. FIG. 8D shows the binary data of 600 dpi in the X direction and 1,200 dpi in the Y direction after the index expansion processing, and the positional relationship between the data and the nozzles of the black nozzle array 1101 in a case where all the quantization data of the respective pixels uniformly indicate “0001” (intermediate density). As shown in FIG. 8D, dots are formed by the Ev nozzles for the 0th, second, fourth, . . . data of the data in the Y direction, and dots are formed by the Od nozzles for the first, third, fifth, . . . data. Thus, printing/non-printing of each nozzle of the black nozzle array 1101 is set for each pixel of the input image data of 600 dpi×600 dpi, thereby setting printing/non-printing of 600 dpi×1200 dpi. The contents of the procedure of the edge processing according to this embodiment have been described above.

The printhead control unit 213 sets, for the Ev nozzle array, the data for the Ev nozzle stored in the RAM 207 and a discharge position adjustment value for the Ev nozzle array. Furthermore, the printhead control unit 213 sets, for the Od nozzle array, the data for the Od nozzle stored in the RAM 207 and a discharge position adjustment value for the Od nozzle array. The printhead H prints an image on the print medium in the main scanning direction based on the data and the discharge position adjustment values. The discharge position adjustment value includes a reference value stored in the ROM 206 and a correction value from a predetermined reference value for each print mode or each image object. The discharge position adjustment value may also include a value corrected from the reference value based on a discharge position adjustment function arbitrarily executed by the user. The discharge position adjustment value may be relative time information or relative position information with respect to the position of the printhead H specified by the encoder strip of the printer 2. The contents of the procedure of discharge position adjustment and image printing according to this embodiment have been described above.

### <Processing of Nozzle Arrays Other Than Black Nozzle Array>

This embodiment has explained the processing of step S803 and the subsequent steps with respect to only the black data. However, in step S802, data other than the black data, that is, the density value data of cyan, magenta, and yellow are also output. The same processing as that for the black data is performed for these data. Alternatively, processing different from that for the black data may be used, as will be described below.

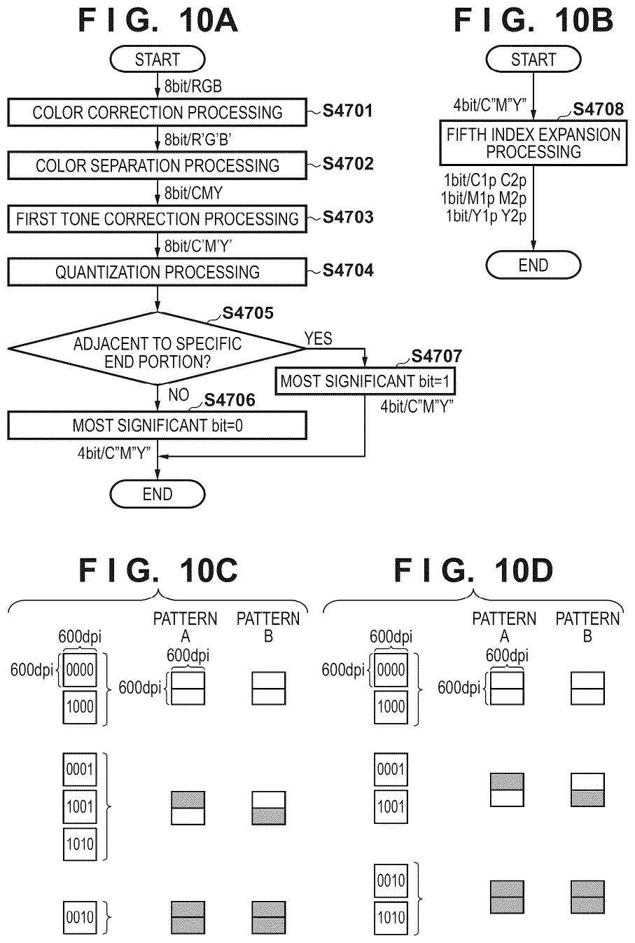

FIGS. 10A and 10B show an example of the internal processing procedure of the color separation/quantization processing executed in step S304 and the nozzle separation processing executed in step S305 with respect to cyan, magenta, and yellow. Steps S4701 and S4702 are the same as steps S801 and S802, respectively. In addition, steps S4703 and S4704 are the same as steps S804 and S809, respectively, and a description thereof will be omitted.

In step S4705, the color separation/quantization unit 211 outputs 4-bit quantization data C″, M″, and Y″ based on whether the processed pixel is a pixel adjacent to a specific end portion using the result determined in step S303. The specific end portion is, for example, the first end portion or the second end portion. More specifically, if it is detected that the pixel is a pixel adjacent to the specific end portion, the most significant bit of the quantization data=1 is set in step S4707; otherwise, the most significant bit of the quantization data=0 is set in step S4706.

In step S4708, the nozzle separation processing unit 212 performs index expansion processing for each of the quantization data C″, M″, and Y″ output in step S304. In the index expansion processing in this example, the quantization data C″, M″, and Y″ of 600 dpi×600 dpi are converted into binary nozzle data C1p, C2p, M1p, M2p, Y1p, and Y2p of 600 dpi×600 dpi using the index pattern prepared in advance.

FIGS. 10C and 10D are views each showing an example of a dot arrangement pattern used in the index expansion processing. FIG. 10C shows an arrangement pattern for Y″, and FIG. 10D shows an arrangement pattern for C″ and M″. Each of the dot arrangement patterns shown in FIGS. 10C and 10D are obtained by vertically connecting pieces of arrangement information of 600 dpi×1200 dpi. In a case where “0000” or “1000” is indicated for each of the quantization data C″, M″, and Y″, no dot of the corresponding color is arranged on either the upper side or the lower side of the pixel. In a case where “0001” is indicated for each of the quantization data C″, M″, and Y″, pattern A in which a dot of the corresponding color is arranged on the upper side and pattern B in which a dot of the corresponding color is arranged on the lower side are prepared. In a case where “0010” is indicated for each of the quantization data C″, M″, and Y″, a dot of the corresponding color is surely arranged on each of the upper side and the lower side of the pixel. With respect to each of the quantization data C″ and M″, even in a case where “1010” is indicated, a dot of the corresponding color is surely arranged on each of the upper side and the lower side of the pixel. On the other hand, if “1010” is indicated for the quantization data Y″, pattern A in which a dot of the corresponding color is arranged on the upper side and pattern B in which a dot of the corresponding color is arranged on the lower side are prepared. A reference index pattern is the same as in FIG. 8C. Then, the nozzle separation processing unit 212 generates data of the upper side among the pieces of arrangement information of the upper and lower sides of a cyan dot of each pixel as data for the Ev nozzle of the cyan nozzle array 1102 corresponding to each pixel, which is the nozzle data C1p, and stores the data in the RAM 207. Furthermore, the nozzle separation processing unit 212 generates data of the lower side among the pieces of arrangement information of the upper and lower sides of a cyan dot of each pixel as data for the Od nozzle of the cyan nozzle array 1102 corresponding to each pixel, which is the nozzle data C2p, and stores the data in the RAM 207. The same applies to magenta and yellow. As described above, with respect to cyan and magenta, the same dot arrangement is obtained regardless of whether the pixel is adjacent to the specific end portion, and thus dots are not thinned. On the other hand, with respect to yellow, in a case where the pixel is adjacent to the specific end portion, dots are thinned. It has been described with respect to yellow that dots are thinned in a case where the pixel is adjacent to the specific end portion, but without limitation to yellow, with respect to cyan or magenta as well, dots may be thinned in a case where the pixel is adjacent to the specific end portion. The processing for nozzle arrays other than the black nozzle array has been explained above. Note that this description is common to all embodiments to be described below.

### First Embodiment

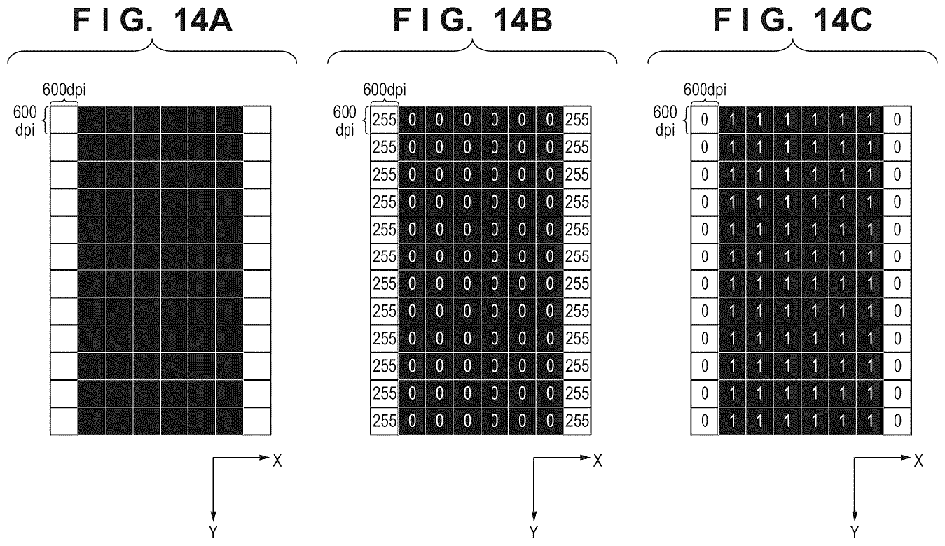

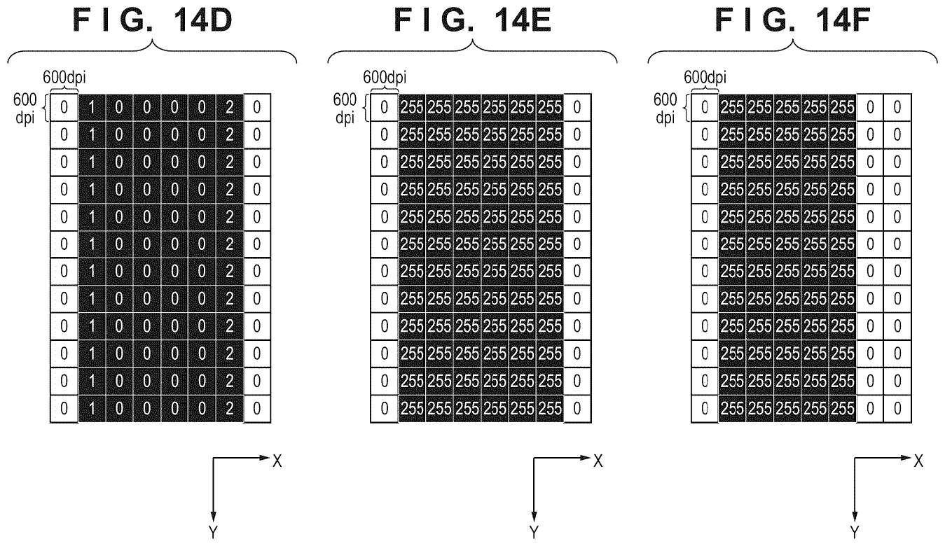

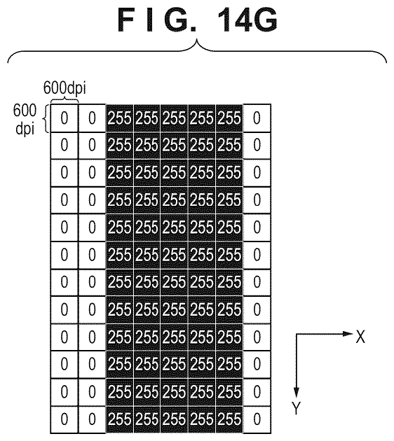

An example of performing edge processing using this embodiment will be described based on the procedure shown in FIGS. 3A to 8D with reference to FIGS. 14A to 17C. FIG. 14A is a view showing an input image used in this description, in which a vertical line is arranged as an object of an image. The vertical line is an image uniformly extending in the array direction of the nozzles of a printhead H. In FIG. 14A, pixels are arrayed at 600 dpi, each pixel has a 8-bit, 256-level luminance value for each of R, G, and B, and so-called black pixels having luminance values of 0 for R, G, and B form a line having a pixel width of six pixels in the X direction as a direction intersecting the array direction of the nozzles.

After the input image is acquired by an image processing unit 208 in step S301, a decoder unit 209 performs decoding processing for the input image in step S302. For the sake of simplicity, assume that the image having undergone the decoding processing is the same as that shown in FIG. 14A. For the image having undergone the decoding processing, in step S303, an image analysis unit 210 detects a specific end portion to which each pixel corresponds. FIG. 14B is a view showing data of the luminance Y after luminance conversion in step S401. FIG. 14C is a view showing binary data obtained by binarizing the data of the luminance Y in step S402 by setting Th=50. FIG. 14D is a view showing a result of determining edges for the above-described binary data. In FIG. 14D, “0” indicates non-detection, “1” indicates the left end portion, and “2” indicates the right end portion on the opposite side of the left end portion in the scanning direction of the printhead.

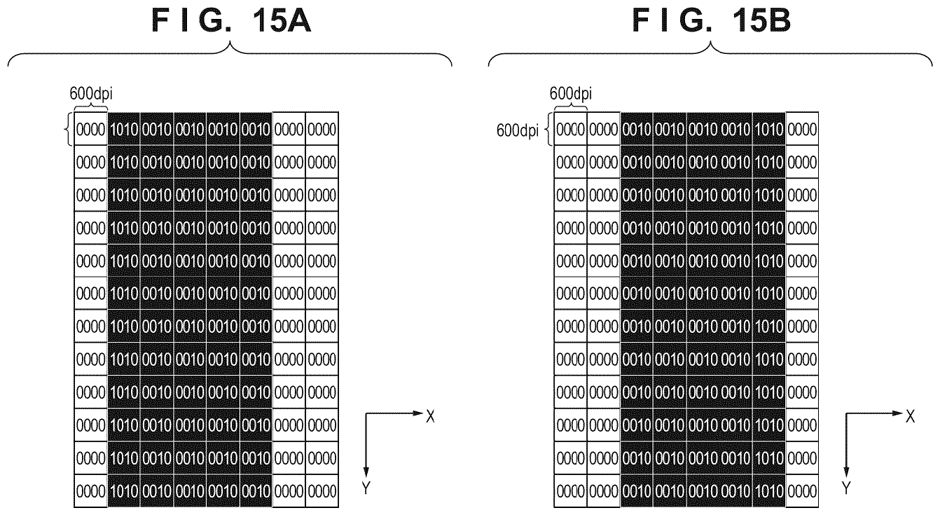

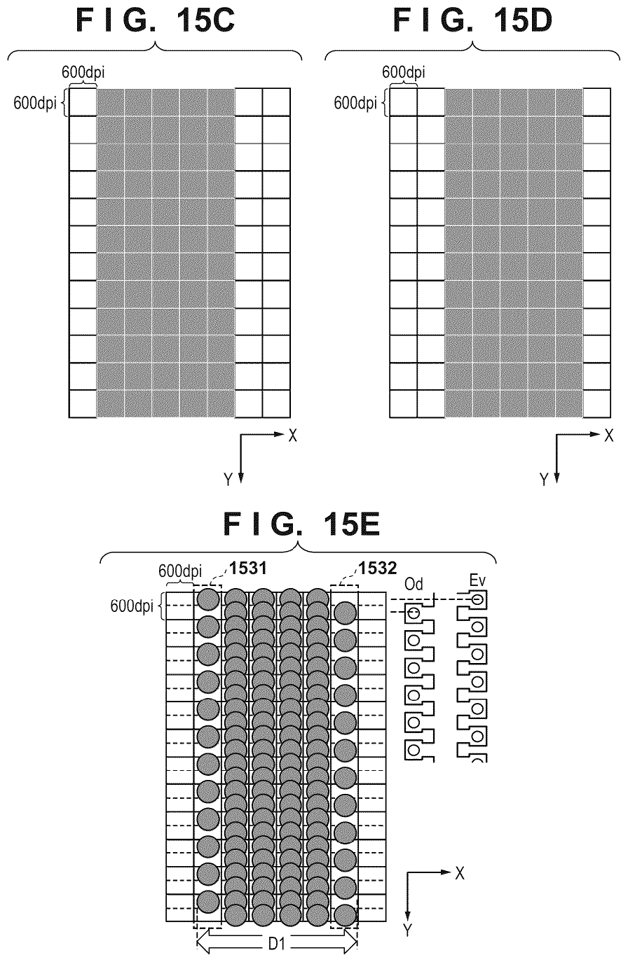

Next, in step S304, based on the edge end portion detection result of step S303, the color separation/quantization unit 211 performs color separation/quantization processing for the image having undergone the decoding processing in step S302. FIG. 14E is a view showing density values K1 and K2 after performing the color separation processing in step S802. FIG. 14F is a view showing a density value K1′ after the tone correction processing in steps S803 to S805 but shows an example in which the second end portion is determined as the right end portion in step S803. Therefore, pixels indicated by “2” in FIG. 14D, that is, right end pixels have a density value of 0. FIG. 14G is a view showing a density value K2′ after the tone correction processing in steps S806 to S808 but shows an example in which the first end portion is determined as the left end portion in step S806. Therefore, pixels indicated by “1” in FIG. 14D, that is, left end pixels have a density value of 0. FIG. 15A is a view showing quantization data K1″ having undergone steps S809 to S812, and FIG. 15B is a view showing quantization data K2″ having undergone steps S813 to S816. An example in which a density value of 128 is quantized to “0001” and a density value of 255 is quantized to “0010” in both steps S809 and S813 is shown. The definitions of the first end portion and the second end portion in steps S810 and S814 are the same as in steps S803 and S806, respectively. Therefore, as shown in FIG. 15A, among pixels of K1′=255 in FIG. 14F, pixels indicated by “1” in FIG. 14D, that is, left end pixels have quantization data “1010” and the remaining pixels have “0010”. On the other hand, as shown in FIG. 15B, among pixels of K2′=255 in FIG. 14G, pixels indicated by “2” in FIG. 14D, that is, right end pixels have quantization data “1010” and the remaining pixels have “0010”.

Next, in step S305, the image quantized in step S304 undergoes the index expansion processing by the nozzle separation processing unit 212. FIGS. 15C and 15D are views respectively showing nozzle data K1p and K2p after the index expansion processing in steps S817 and S818. FIG. 15E is a view showing a dot arrangement when the printhead H having the second flight characteristic executes printing at 600 dpi×1200 dpi based on the nozzle data K1p and K2p. By comparing FIGS. 14B, 14D, and 15E, it is found that in each of pixels, which is neither the left end portion nor the right end portion in FIG. 14D, among pixels having a luminance value of 0 in FIG. 14B, a dot is arranged in each region of 600 dpi×1200 dpi in FIG. 15E. Then, it is found that in each pixel determined as the left end portion in FIG. 14D among the pixels having a luminance value of 0 in FIG. 14B, a dot is arranged only by the upstream side nozzle, that is, the Ev nozzle in FIG. 15E. Furthermore, it is found that in each pixel determined as the right end portion in FIG. 14D among the pixels having a luminance value of 0 in FIG. 14B, a dot is arranged only by the downstream side nozzle, that is, the Od nozzle in FIG. 15E.

In this embodiment, the dot arrangement shown in FIG. 15E is not printed intact on a print medium, and the dot position is further adjusted by a discharge position adjustment value set by a printhead control unit 213 in step S501.

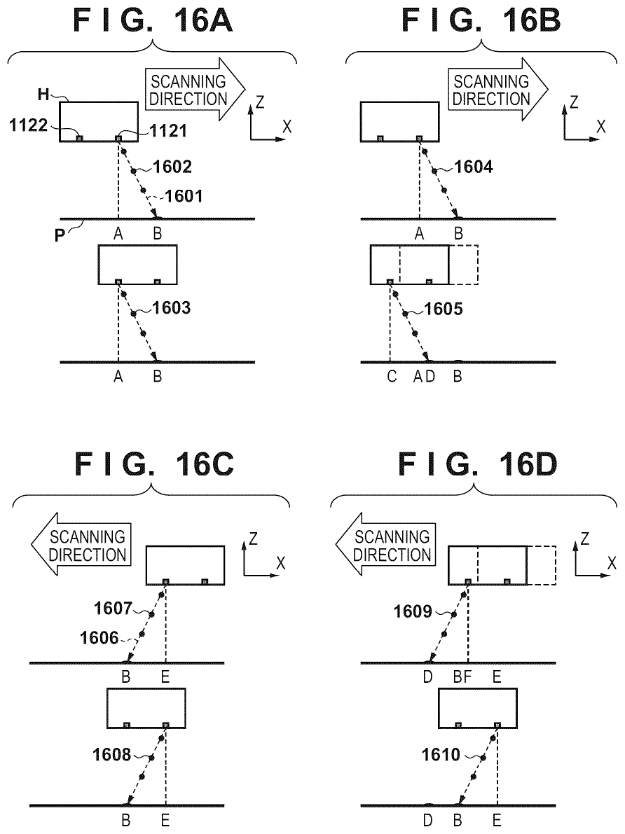

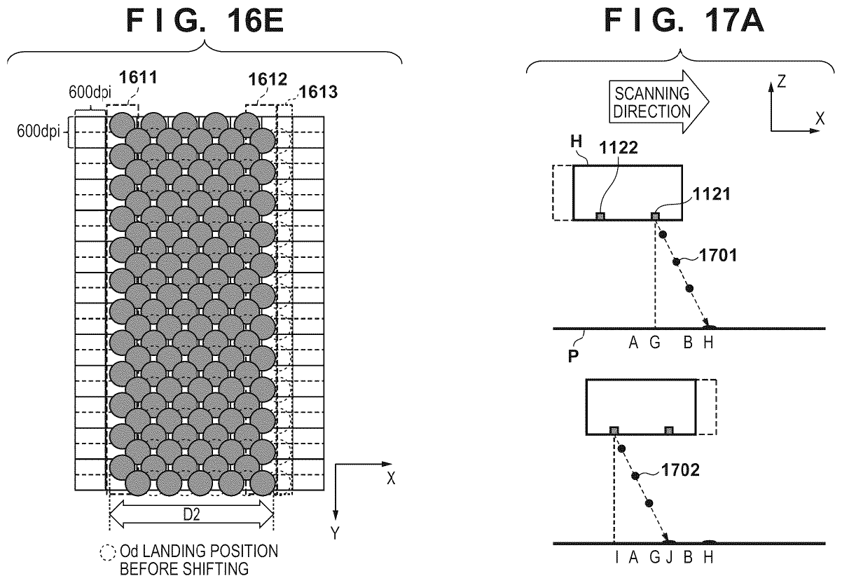

FIGS. 16A to 16E are views for explaining an example, and shows an example in a case where the Ev nozzle included in the Ev nozzle array and the Od nozzle included in the Od nozzle array form dots in a non-edge pixel at point B on the print medium. For the sake of simplicity, an ink droplet discharged from the Ev nozzle and an ink droplet discharged from the Od nozzle at the time of non-scanning of the printhead have directions horizontal to the Z direction.

FIGS. 16A and 16C are views in a case where the dot position is not adjusted, in other words, a case where the Ev nozzle array and the Od nozzle array discharge ink at the same location as point B. As shown in FIG. 16A, an ink droplet discharged from each nozzle lands on the print medium after following a trajectory 1601 because of the inertial in the scanning direction of the printhead H. Therefore, by the encoder strip and the discharge position adjustment value, a printhead control unit 213 causes the Ev nozzle to discharge ink at a timing when it is determined that the Ev nozzle array has reached point A on the print medium, thereby making an ink droplet 1602 land at point B. After that, the printhead control unit 213 causes the Od nozzle to discharge ink at a timing when it is determined that the Od nozzle array has reached point A on the print medium, thereby making an ink droplet 1603 land at point B. FIG. 16C is a view in a case where the printhead H perform backward scanning, and an ink droplet discharged from each nozzle lands on the print medium after following a trajectory 1606 because of the inertial in the −X direction of the printhead H. Therefore, by the encoder strip and the discharge position adjustment value, the printhead control unit 213 causes the Od nozzle to discharge ink at a timing when it is determined that the Od nozzle array has reached point E on the print medium, thereby making an ink droplet 1607 land at point B. After that, the printhead control unit 213 causes the Ev nozzle to discharge ink at a timing when it is determined that the Ev nozzle array has reached point E on the print medium, thereby making an ink droplet 1608 land at point B. This forms the dot arrangement shown in FIG. 15E regardless of the scanning direction of the printhead H, and the landing dot width in the X direction at this time is D1. Note that as in the known edge processing technique, even in a case where dots of the Ev nozzle and the Od nozzle are mixed in both the left end portion and the right end portion, the landing dot width in the X direction is substantially equal to D1.

To the contrary, FIGS. 16B and 16D are views respectively showing forward scanning and backward scanning in a case where the dot position is adjusted. In the case of forward scanning, as shown in FIG. 16B, by the encoder strip and the discharge position adjustment value, the printhead control unit 213 causes the Ev nozzle to discharge ink at a timing when it is determined that the Ev nozzle array has reached point A on the print medium, thereby making an ink droplet 1604 land at point B. After that, by the encoder strip and the discharge position adjustment value, the printhead control unit 213 causes the Od nozzle to discharge ink at a timing when it is determined that the Od nozzle array has reached point C offset in the −X direction from point A on the print medium. This makes an ink droplet 1605 land at point D offset in the −X direction from point B on the print medium. By setting the discharge position adjustment value to a resolution higher than a printing resolution, the distance in the X direction between points B and D can be adjusted at a resolution of less than 1-pixel width. In the case of backward scanning, as shown in FIG. 16D, by the encoder strip and the discharge position adjustment value, the printhead control unit 213 causes the Od nozzle to discharge ink at a timing when it is determined that the Od nozzle array has reached point F offset in the −X direction from point E on the print medium. This makes an ink droplet 1609 land at point D. After that, the printhead control unit 213 causes the Ev nozzle to discharge ink at a timing when it is determined that the Ev nozzle array has reached point E on the print medium, thereby making an ink droplet 1610 land at point B. FIG. 16E shows the dot arrangement formed by forward scanning and backward scanning by this adjustment. The flight characteristic of the printhead H in FIG. 16E is the same as in FIG. 15E. With respect to FIG. 15E, the landing positions of the dots formed by Od nozzles are uniformly offset in the −X direction, and a landing dot width D2 in the X direction is smaller than D1. Furthermore, since the offset amount of the position can be set to less than the 1-pixel width, D2 can also be adjusted to less than the 1-pixel width. That is, the width of the line formed on the print medium can be adjusted to less than the 1-pixel width.

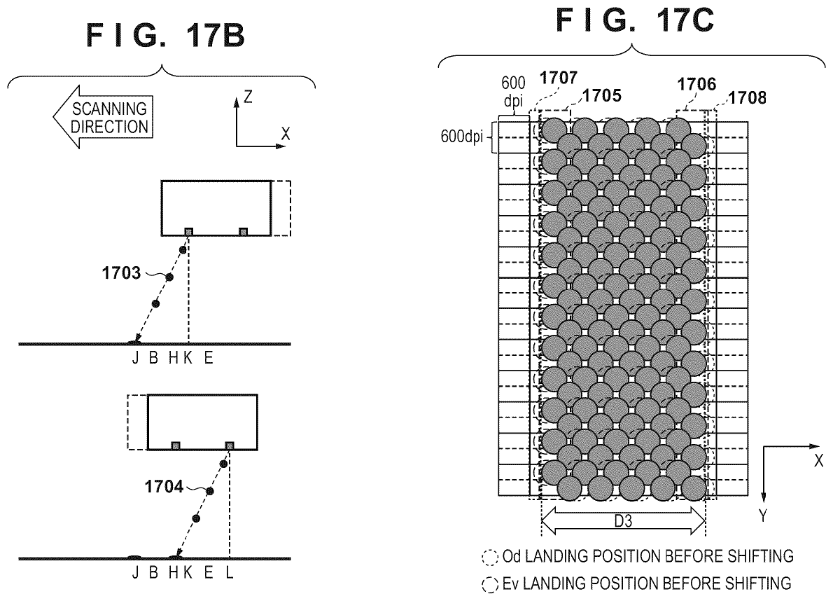

Note that an example of executing discharge position adjustment for only the Od nozzle array has been described with reference to FIGS. 16A to 16E but the present disclosure is not limited to this. FIGS. 17A to 17C are views showing an example of performing adjustment for both the Ev nozzle array and the Od nozzle array. In the case of forward scanning, as shown in FIG. 17A, by the encoder strip and the discharge position adjustment value, the printhead control unit 213 causes the Ev nozzle to discharge ink at a timing when it is determined that the Ev nozzle array has reached point G offset in the +X direction from point A on the print medium. This makes an ink droplet 1701 land at point H offset in the +X direction from point B on the print medium. After that, by the encoder strip and the discharge position adjustment value, the printhead control unit 213 causes the Od nozzle to discharge ink at a timing when it is determined that the Od nozzle array has reached point I offset in the −X direction from point A on the print medium. This makes an ink droplet 1702 land at point J offset in the −X direction from point B on the print medium. The distance in the X direction between points H and J is equal to the distance in the X direction between points B and D in FIGS. 16B and 16D, and the distance in the X direction between points H and B is equal to the distance in the X direction between points J and B. In the case of backward scanning, as shown in FIG. 17B, by the encoder strip and the discharge position adjustment value, the printhead control unit 213 causes the Od nozzle to discharge ink at a timing when it is determined that the Od nozzle array has reached point K offset in the −X direction from point E on the print medium. This makes an ink droplet 1703 land at point J on the print medium. After that, by the encoder strip and the discharge position adjustment value, the printhead control unit 213 causes the Ev nozzle to discharge ink at a timing when it is determined that the Ev nozzle array has reached point L offset in the +X direction from point E on the print medium. This makes an ink droplet 1704 land at point H on the print medium. FIG. 17C shows the dot arrangement formed by forward scanning and backward scanning by this adjustment. The flight characteristic of the printhead H in FIG. 17C is the same as in FIG. 15E. With respect to FIG. 15E, the landing position of the dots formed by Ev nozzles and the landing positions of the dots formed by the Od nozzles are offset in the +X direction and the −X direction, respectively, and a landing dot width D3 in the X direction is smaller than D1 and equal to D2. That is, similar to FIG. 16E, the line width formed on the print medium can be narrowed.

Note that this embodiment has explained an example in which the black vertical line is arranged on the white background but the present disclosure is not limited to this. Especially in a case where the background is not white, no dot is arranged in a region 1613 in the dot arrangement shown in FIG. 16E, and the portion may look white depending on contrast with the background color. On the other hand, in the case shown in FIG. 17C, regions 1707 and 1708 are generated as regions where no dot is arranged. Since the width in the X direction of the region is half of the region 1613, the possibility that the portion looks white can be reduced. Note that this embodiment has explained the example in which the distance in the X direction between points H and B is equal to the distance in the X direction between points J and B, that is, the ratio between the distances is 1:1, but the present disclosure is not limited to this. Even if the ratio is set to another value such as 2:1, the line width formed on the print medium can be narrowed. Note that a modification of the position adjustment amount is the same also in the following embodiments.

The example in a case where the printhead H has the second flight characteristic has been explained above but a printhead having the first flight characteristic may be adopted. FIGS. 20A, 20B, 20D, and 20E are views for explaining an example. FIG. 20A is a view when an ink droplet generated by one discharge operation of each of the Ev nozzle and the Od nozzle of the printhead H having the second flight characteristic is caused to land at the same point on the X-axis on the print medium. As shown in FIG. 20A, both the dot of the Ev nozzle and the dot of the Od nozzle include satellites that do not land at positions different from the main droplets 2001 and 2002 regardless of the scanning direction, and thus the ink droplets are caused to land so that center positions 2003 and 2004 are the same position on the X-axis. FIG. 20B is a view when an ink droplet generated by one discharge operation of each of the Ev nozzle and the Od nozzle of the printhead H having the first flight characteristic is caused to land at the same point in the X direction on the print medium. As shown in FIG. 20B, the dot of the Od nozzle includes a satellite that does not land at a position different from a main droplet 2007 in forward scanning but the dot of the Ev nozzle includes a satellite 2006 that lands at a position different from a main droplet 2005. Note that in the case of backward scanning, the characteristic of the Ev nozzle and the Od nozzle is reversed from that in the case of forward scanning. In this case, for the purpose of improving the graininess of the print image, landing may be aimed at, as shown in FIG. 20B. More specifically, instead of aligning the position of a center 2010 of the main droplet 2005 and the position of a center 2009 of the main droplet 2007 at the same point on the X-axis, droplets are made to land so that the center 2009 is aligned with a position 2008 that is substantially the same as the position of the center of gravity obtained by combining the main droplet 2005 and the satellite 2006. At this time, the center 2009 is substantially equal to the position of the center of gravity of the main droplet 2007. That is, the droplets are made to land so that the position of the center of gravity of a dot group by the Ev nozzles and the position of the center of gravity of a dot group by the Od nozzles are substantially the same on the X-axis.

FIGS. 20D and 20E each show a dot arrangement formed when performing the processes of steps S301 to S501 for the input image shown in FIG. 14A by setting, as a reference position, the landing position relationship shown in FIG. 20B. FIG. 20D shows a dot arrangement in the case of forward scanning, and FIG. 20E shows a dot arrangement in the case of backward scanning. FIGS. 20D and 20E each show a case where discharge position adjustment based on step S501 is performed only for the Od nozzle array, and a broken line in each of FIGS. 20D and 20E represents the position of a dot formed by the Od nozzle when no discharge position adjustment is performed. As shown in FIGS. 20D and 20E, the landing positions of dots formed by the Od nozzles are uniformly offset in the −X direction, and landing dot widths D4 and D5 in the X direction are smaller than those before discharge position adjustment. Furthermore, by adjusting the discharge position of the Od nozzle array to less than the 1-pixel width, a satellite 2013 obtained by discharge of the Ev nozzle in the forward scanning is located inside a main droplet 2014 of the Od nozzle after the discharge position adjustment. Similarly, a satellite 2016 obtained by discharge of the Od nozzle in the backward scanning is located inside a main droplet 2015 of the Ev nozzle. That is, in the printhead H having the first flight characteristic, the line width formed on the print medium can be narrowed and a decrease in sharpness of the edge caused by the satellites can be suppressed regardless of the scanning direction.

Note that FIGS. 20D and 20E each show the example in which discharge position adjustment based on step S501 is performed only for the Od nozzle array. However, even if the positions of the Ev nozzle array and the Od nozzle array are adjusted, as shown in FIGS. 17A and 17B, it is possible to obtain the same effect.

### Second Embodiment

The second embodiment will be described below concerning points different from the first embodiment. The first embodiment has explained processing in a case where a vertical line having a width of six pixels is an object of an input image and the width in the X direction of an edge is one pixel. In this case, as shown in FIGS. 16E and 17C, the dot arrangement density of end regions 1611, 1612, 1705, and 1706 after dot position adjustment is higher than the density of end regions 1531 and 1532 of FIG. 15E. In general, as the dot arrangement density of the edge is lower, bleeding of ink on the print medium is less, and the sharpness of the edge is satisfactory. In this embodiment, processing in a case where an edge width is two pixels will be described as a configuration of narrowing a line width formed on a print medium and reducing dot arrangement density. Note that steps S301 and S302 are the same as in the first embodiment and a description thereof will be omitted.

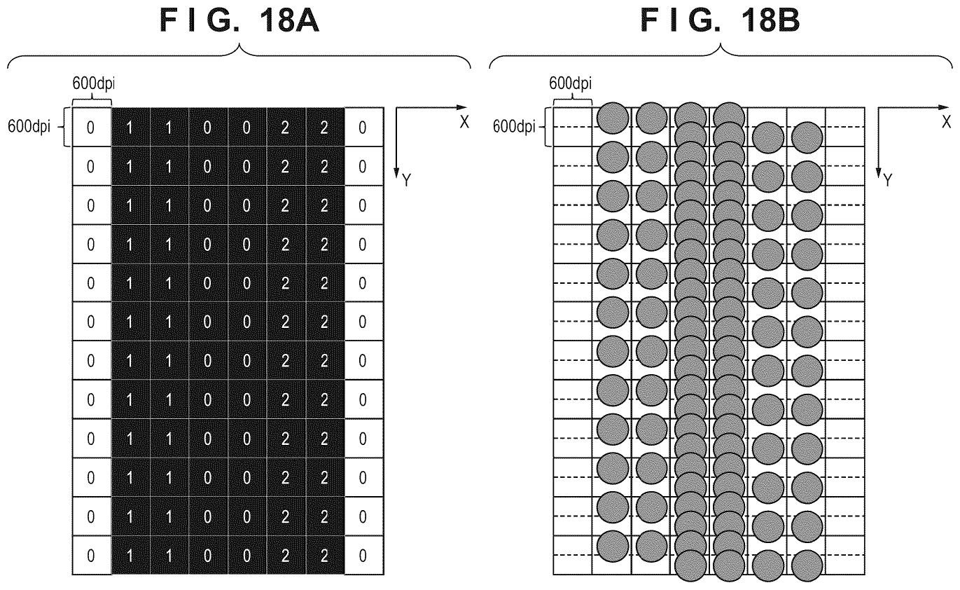

In image analysis processing executed in step S303, an image analysis unit 210 detects the first pixels in the left end portion and their adjacent second pixels at the time of edge detection in step S403, thereby collectively detecting these pixels as the left end portion. Similarly, the image analysis unit 210 detects the first pixels in the right end portion and their adjacent second pixels, thereby collectively detecting these pixels as the right end portion. FIG. 18A is a view showing a result of determining edges with respect to binary data shown in FIG. 14C. In FIG. 14C, “0” indicates non-detection, “1” indicates the left end portion, and “2” indicates the right end portion. Steps S304 and S305 thereafter are the same as in the first embodiment and a description thereof will be omitted. FIG. 18B is a view showing a dot arrangement after performing index expansion processing in step S305 according to this embodiment. As shown in FIG. 18B, dots are arranged only by the Ev nozzles for a width of two pixels in the left end portion, and dots are arranged only by the Od nozzles for a width of two pixels in the right end portion.

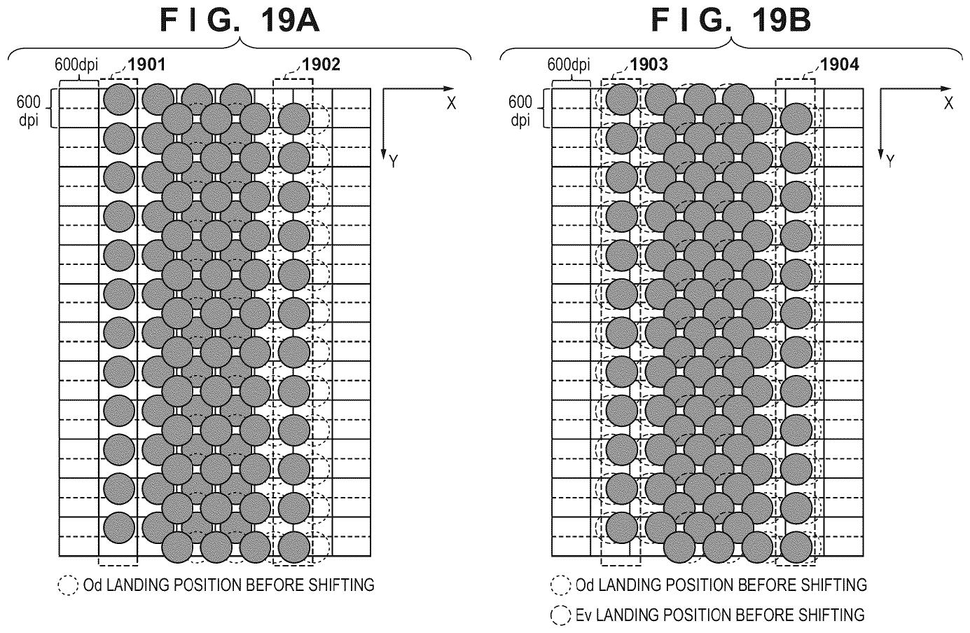

Subsequently, a dot position is adjusted by a discharge position adjustment value set by a printhead control unit 213 in step S501 but this processing is the same as in the first embodiment and a description thereof will be omitted. FIG. 19A shows a dot arrangement obtained when performing discharge position adjustment shown in FIGS. 16B and 16D for the dot arrangement shown in FIG. 18B, and FIG. 19B shows a dot arrangement obtained when performing discharge position adjustment shown in FIGS. 17A and 17B for the dot arrangement shown in FIG. 18B. Note that FIGS. 19A and 19B each show a case where a printhead H has the second flight characteristic. As shown in FIGS. 19A and 19B, the dot arrangement density of end regions 1901, 1902, 1903, and 1904 after dot position adjustment is lower than the density of the end regions 1611, 1612, 1705, and 1706 of FIGS. 16E and 17C, and is substantially equal to the density of the end regions 1531 and 1532 of FIG. 15E. Thus, it is possible to obtain edges with good sharpness and less bleeding of ink on the print medium by further decreasing the dot density of the end regions while narrowing the line width formed on the print medium by dot position adjustment, similar to the first embodiment.

The processing of setting the edge width to two pixels, which has been described in this embodiment, is effective even in a case where the printhead H has the first flight characteristic. In addition to a case where the positions of a main droplet and a satellite on the print medium are relatively close to each other, as shown in FIG. 20B, the processing is also effective in a case where a plurality of satellites 2011 land on the print medium or the distance between a main droplet 2005 and the satellite 2011 is large, as shown in FIG. 20C. Note that as described above, in FIG. 20C as well, a case where a droplet is made to land so that a position 2012 of the center of gravity, which is substantially the same as the position of the center of gravity of a dot group by the Ev nozzles, and a center 2009 of a dot group by the Od nozzles are substantially the same on the X-axis is set as a reference position.

FIG. 20F shows a dot arrangement in forward scanning when the processes of steps S301 to S305 are performed for the input image shown in FIG. 14A by setting an edge width to one pixel, similar to the first embodiment, while setting the landing position relationship shown in FIG. 20C as a reference position. As shown in FIG. 20F, there is no large difference between the position in the X direction of a satellite 2017 landing at a position farthest from the main droplet discharged from the Ev nozzle and the position of a dot 2018 of the Od nozzle. In a case where discharge position adjustment based on step S501 is performed, the satellite 2017 may be located outside the edge depending on the adjustment value, as shown in FIG. 20G, thereby decreasing the sharpness of the edge.

To the contrary, in this embodiment, in a case where the edge width is set to two pixels, FIG. 20H shows a dot arrangement in forward scanning when the processes of steps S301 to S305 are performed, and FIG. 20I shows a dot arrangement in forward scanning when discharge position adjustment based on step S501 is performed. As shown in FIG. 20I, even if discharge position adjustment is performed, the position in the X direction of the satellite 2017 from the Ev nozzle is located inside the dot 2018 of the Od nozzle. Furthermore, a landing dot width D7 in the X direction is smaller than D6 before discharge position adjustment. That is, even for the printhead H which has the first flight characteristic and in which the landing positions of a main droplet and a satellite are far from each other, it is possible to narrow the line width formed on the print medium and suppress a decrease in sharpness of the edge caused by the satellite by setting the edge width to two pixels and performing discharge position adjustment. Note that FIG. 20I shows a case where discharge position adjustment based on step S501 is performed only for the Od nozzle array. However, by adjusting the position of each of the Ev nozzle array and the Od nozzle array, as shown in FIGS. 17A and 17B, it is also possible to obtain the same effect. Furthermore, FIG. 20I shows the dot arrangement in forward scanning but it is possible to obtain the same effect even in backward scanning.

### Third Embodiment

The third embodiment will be described below concerning points different from the first and second embodiments. Each of the first and second embodiments has explained an example in which an input image is a vertical line having a pixel width of six pixels in the X direction. This embodiment will describe processing in a case where an input image is a vertical line having another pixel width. Note that steps S301 and S302 are the same as in the first embodiment and a description thereof will be omitted. An example in which a printhead H has the first flight characteristic in which FIG. 20C is set as a reference position will be described.

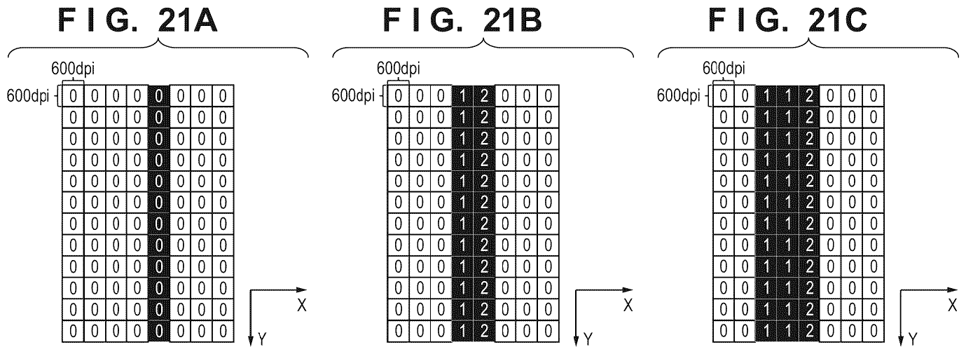

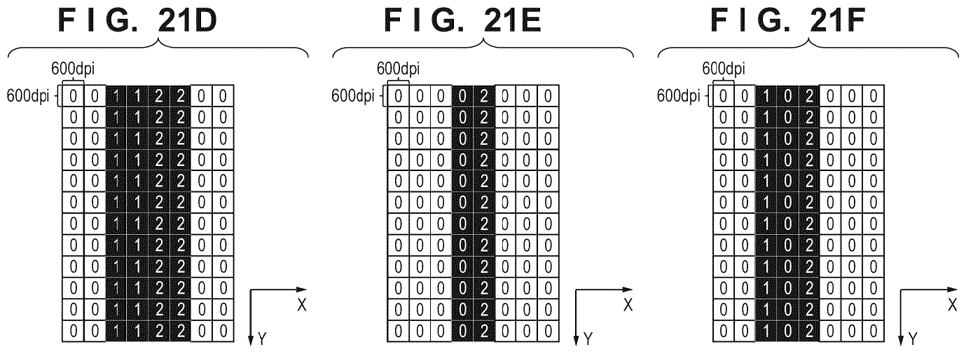

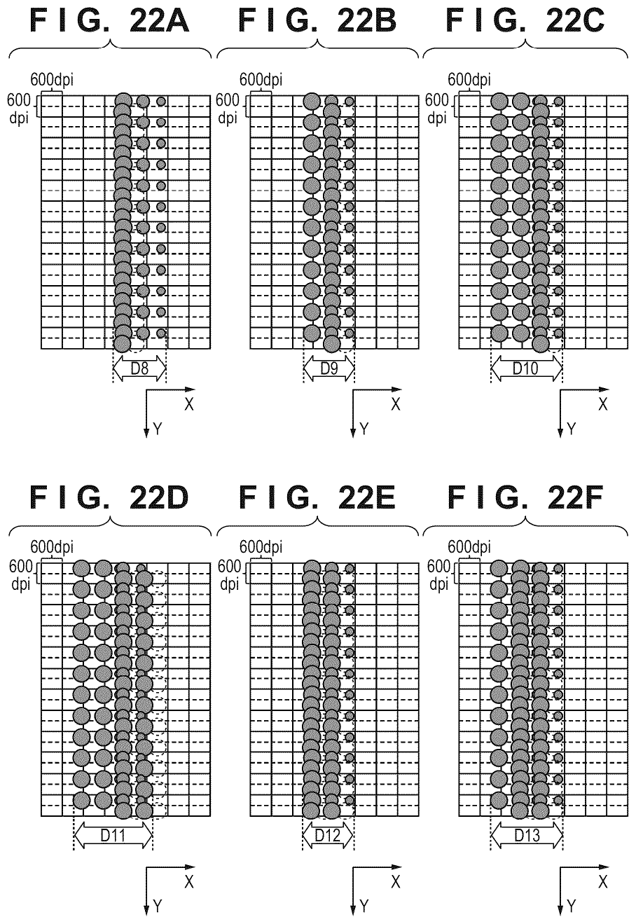

FIGS. 21A to 21F show results obtained when an image analysis unit 210 performs edge detection in image analysis processing executed in step S303 in a case where vertical lines (to be referred to as 1- to 4-pixel vertical lines hereinafter) having pixel widths of one to four pixels in the X direction are used as input images, respectively. In FIGS. 21A to 21F, “0” indicates non-detection, “1” indicates the left end portion, and “2” indicates the right end portion. FIGS. 22A to 22F are views of dot arrangements on a print medium after performing processes of steps S303 to S501 for FIGS. 21A to 21F, respectively.

In the case of a vertical line having a 1-pixel width, as shown in FIG. 21A, the image analysis unit 210 determines a vertical line portion as “0”, that is, does not detect the vertical line portion as an end portion, the dot arrangement is obtained as shown in FIG. 22A, and thus dots on the print medium are not thinned. This is because if the dots are thinned similar to the first embodiment, in the case of the 1-pixel vertical line, the number of dots on the print medium is halved and an object itself is thin, and thus the user may readily visually perceive a change in density caused by thinning. Note that in this case, the landing position of an Od nozzle can change, by a discharge position adjustment value set in step S501, from an original position indicated by a broken line, but the influence on a landing dot width D8 in the X direction is small.

In the case of a vertical line having a 2-pixel width, as shown in FIG. 21B, the image analysis unit 210 detects the left pixels and the right pixels as the left end portion “1” and the right end portion “2”, respectively, and the dot arrangement is as shown in FIG. 22B. In this case, the landing position of the Od nozzle can change, by the discharge position adjustment value set in step S501, from the original position indicated by a broken line but the influence on a landing dot width D9 in the X direction is small. Note that as shown in FIG. 22B, the positions of the main droplet of an Ev nozzle and the main droplet of the Od nozzle become closer to each other by discharge position adjustment, and thus D9 may be become smaller by discharge position adjustment depending on the flight characteristic of the printhead H. In the case of the 2-pixel vertical line, the form may be as shown in FIGS. 21E and 22E. That is, the image analysis unit 210 may detect the left pixels of the 2-pixel vertical line as “0”, that is, need not detect the left pixels as an end portion, and in the dot arrangement, the left pixels need not be thinned, as shown in FIG. 22E. In this case as well, a landing dot width D12 in the X direction is similar to D9, and the number of dots to be reduced on the print medium is decreased to make it difficult to visually perceive a change in density caused by thinning. Note that the same effect is obtained even by a configuration in which the image analysis unit 210 detects the left pixels of the 2-pixel vertical line as the left end portion “1” and detects the right pixels as “0”, that is, does not detect the right pixels as an end portion.

In the case of a vertical line having a 3-pixel width, as shown in FIG. 21C, the image analysis unit 210 detects the left end pixels and the central pixels as the left end portion “1” and the right end pixels as the right end portion “2”, and the dot arrangement is as shown in FIG. 22C. In this case, the landing position of the Od nozzle changes, by the discharge position adjustment value set in step S501, from the original position indicated by a broken line but the influence on a landing dot width D10 in the X direction is small. Note that as shown in FIG. 22C, the positions of the main droplet of the Ev nozzle and the main droplet of the Od nozzle become closer to each other by discharge position adjustment, and thus D10 may be become smaller by discharge position adjustment depending on the flight characteristic of the printhead H. Note that the image analysis unit 210 may detect the central pixels as the right end portion “2”. In the case of the 3-pixel vertical line, the form may be as shown in FIGS. 21F and 22F. That is, the image analysis unit 210 may detect the central pixels of the 3-pixel vertical line as “0”, that is, need not detect the central pixels as an end portion, and in the dot arrangement, the central pixels need not be thinned, as shown in FIG. 22F. In this case as well, a landing dot width D13 in the X direction is similar to D10, and the number of dots to be reduced on the print medium is decreased to make it difficult to visually perceive a change in density caused by thinning.

In the case of a vertical line having a 4-pixel width, as shown in FIG. 21D, the image analysis unit 210 detects the left end pixels and their adjacent pixels as the left end portion “1” and the right end pixels and their adjacent pixels as the right end portion “2”, and the dot arrangement is as shown in FIG. 22D. In this case, the landing position of the Od nozzle changes, by the discharge position adjustment value set in step S501, from the original position indicated by a broken line, and the landing dot width D11 in the X direction is smaller than that before discharge position adjustment. That is, the line width formed on the print medium can be narrowed. Note that with respect to the pixels adjacent to the end portion, the form shown in FIGS. 21D and 22D need not be adopted. For example, the image analysis unit 210 may detect the left pixels or/and the right pixels adjacent to the end portions as “0”, that is, need not detect these pixels as the end portions, and need not thin dots corresponding to the portions. In this case as well, depending on the flight characteristic of the printhead H, a landing dot width in the X direction is made smaller than that before discharge position adjustment and the number of dots to be reduced on the print medium is decreased, thereby making it difficult to visually perceive a change in density caused by thinning.

In the case of a vertical line having a width of five or more pixels, similar to the first and second embodiments, the image analysis unit 210 detects, as the end portions, only left and right end pixels or pixels adjacent to the end portions in addition to the left and right end pixels, and performs processes of steps S303 to S501. Thus, similar to the first and second embodiments, the landing dot width in the X direction is made smaller than that before discharge position adjustment, thereby making it possible to narrow the line width formed on the print medium.

Note that this embodiment has explained an example of adjusting only the Od nozzle array as discharge position adjustment based on step S501 but the present disclosure is not limited to this. For example, even in a configuration in which discharge position adjustment is performed for the Ev nozzle array and the Od nozzle array, as described in the first embodiment, the same effect is obtained.

### Fourth Embodiment

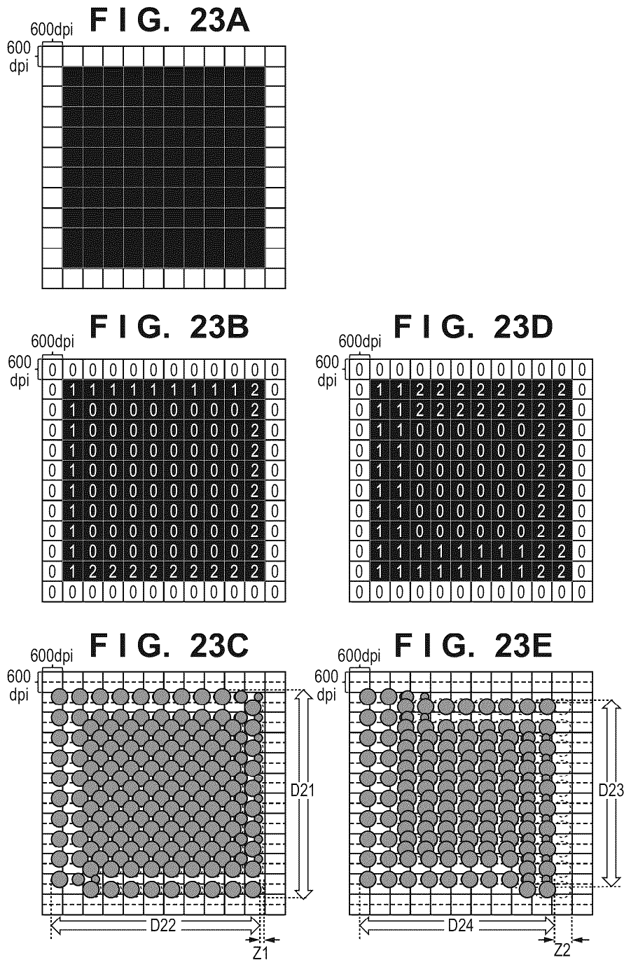

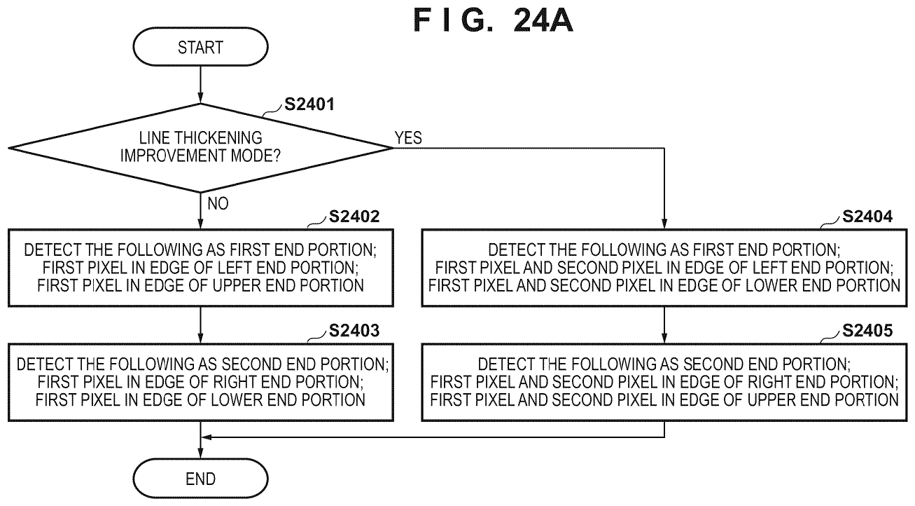

The fourth embodiment will be described below concerning points different from the first to third embodiments. Each of the first to third embodiments has explained an example in which an input image is a vertical line having a predetermined width in the X direction, that is, the scanning direction of the printhead. This embodiment will describe processing in a case where a square image shown in FIG. 23A is set as an input image, as another example of the image. Note that steps S301 and S302 are the same as in the first embodiment and a description thereof will be omitted. An example in which a printhead H has the first flight characteristic in which FIG. 20C is set as a reference position will be described.

FIGS. 23B and 23C are views for explaining an example of processing the input image shown in FIG. 23A by setting the edge width to one pixel. At this time, in image analysis processing executed in step S303, an image analysis unit 210 collectively detects the left end pixels and the upper end pixels as “1” at the time of edge detection in step S403. Similarly, the image analysis unit 210 collectively detects the right end pixels and the lower end pixels as “2”. FIG. 23B shows the detection results at this time, and FIG. 23C shows a dot arrangement obtained after step S501. In discharge position adjustment in step S501, the position of a dot of an Od nozzle is shifted in the −X direction by Z1 with respect to the position of a dot of an Ev nozzle. As shown in FIG. 23C, all of upper, lower, left, and right end regions decrease in dot arrangement density with respect to a region other than the end portions, and it is thus possible to reduce a decrease in sharpness of the upper, lower, left, and right edges. By making a landing dot width D22 in the X direction substantially equal to a landing dot width D21 in the Y direction by discharge position adjustment in step S501, it is possible to make vertical and horizontal line widths formed on the print medium substantially equal to each other, thereby printing an image that is difficult for the user to perceive discomfort.

FIGS. 23D and 23E are views in a case where the input image shown in FIG. 23A is processed by setting the edge width to two pixels. At this time, in the image analysis processing executed in step S303, the image analysis unit 210 collectively detects, as “1”, the first pixels in the left end portion and their adjacent second pixels and the first pixels in the lower end portion and their adjacent second pixels at the time of edge detection in step S403. Similarly, the image analysis unit 210 collectively detects, as “2”, the first pixels in the right end portion and their adjacent second pixels and the first pixels in the upper end portion and their adjacent second pixels. FIG. 23D shows the detection results at this time, and FIG. 23E shows a dot arrangement obtained after step S501. In discharge position adjustment in step S501, the position of a dot of the Od nozzle is shifted in the −X direction by Z2 with respect to the position of a dot of the Ev nozzle, and Z2 is larger than Z1. As shown in FIG. 23E, all of the upper, lower, left, and right end regions decrease in dot arrangement density with respect to a region other than the end portions, and it is thus possible to reduce a decrease in sharpness of the upper, lower, left, and right edges. By reversely setting detection operations of the upper and lower end portions with respect to FIG. 23B in detection of the image analysis unit 210, a landing dot width D23 in the Y direction is smaller than D21. By setting a shift amount occurring due to discharge position adjustment in step S501 to Z2 larger than Z1, a landing dot width D24 in the X direction can be made substantially equal to D23. That is, it is possible to print a sharp image in which both the vertical and horizontal line widths formed on the print medium are thin while maintaining the same reduction level of a decrease in sharpness of the edge, as compared with the landing state shown in FIG. 23C.

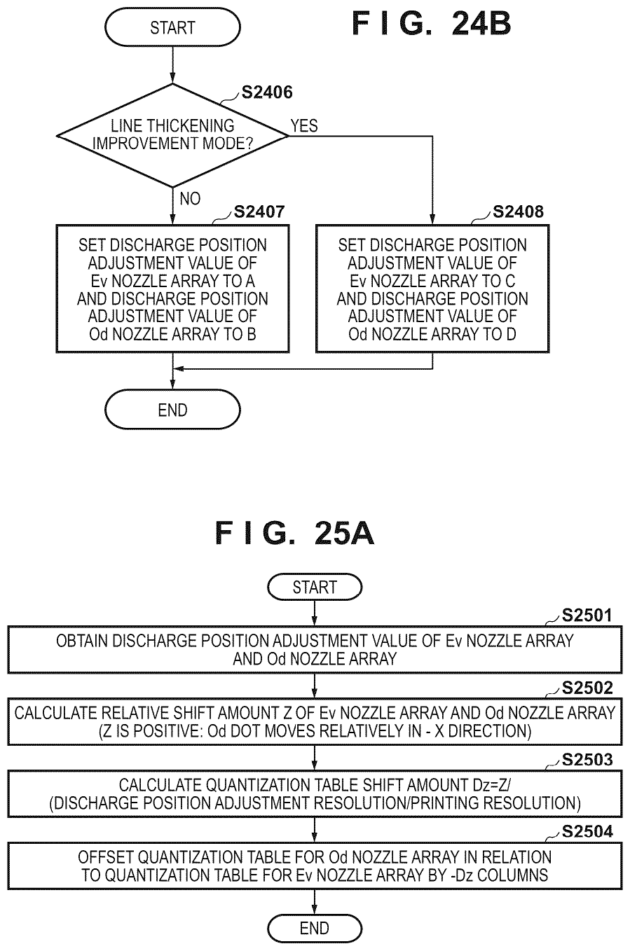

This embodiment has explained the dot arrangement shown in FIG. 23C in which the edge width is set to one pixel and the dot arrangement shown in FIG. 23E in which the edge width is set to two pixels but it may be possible to switch between these dot arrangements in a printer 2. The switching processing can be executed based on information concerning a print mode received by an image forming apparatus 10 from a terminal apparatus 11, for example, information indicating whether the mode is a mode of improving line thickening caused by ink bleeding on the print medium. FIGS. 24A and 24B are views showing an example of the processing. FIG. 24A is a flowchart illustrating the image analysis processing executed in step S303. FIG. 24B is a flowchart illustrating setting of a discharge position adjustment value executed in step S501. If the terminal apparatus 11 does not set a line thickening improvement mode, the image analysis unit 210 performs processes in steps S2402 and S2403. For example, FIG. 23B shows an edge detection result at this time. Furthermore, a printhead control unit 213 performs processing in step S2407. At this time, discharge position adjustment values A and B are values for implementing the dot arrangement shown in FIG. 23C, that is, the arrangement in which the position of the dot of the Od nozzle is shifted in the −X direction by Z1 with respect to the position of the dot of the Ev nozzle. Note that depending on the configurations of the printer 2 and the printhead H, D21 and D22 may be substantially equal to each other even if Z1 is 0. In this case, Z1 may be 0. On the other hand, if the terminal apparatus 11 sets the line thickening improvement mode, the image analysis unit 210 performs processes in steps S2404 and S2405. For example, FIG. 23D shows an edge detection result at this time. Furthermore, the printhead control unit 213 performs processing in step S2408. At this time, discharge position adjustment values C and D are values for implementing the dot arrangement shown in FIG. 23E, that is, the arrangement in which the position of the dot of the Od nozzle is shifted in the −X direction by Z2 with respect to the position of the dot of the Ev nozzle. Thus, the dot arrangement shown in FIG. 23C and the dot arrangement shown in FIG. 23E can be switched in the printer 2, and the user can adjust the line width formed on the print medium.

Note that this embodiment has explained, as the discharge position adjustment configuration, an example of adjusting only the Od nozzle array, but the present disclosure is not limited to this. For example, even in a configuration in which discharge position adjustment is performed for each of the Ev nozzle array and the Od nozzle array, as described in the first embodiment, the same effect as in this embodiment is obtained.

### OTHER EMBODIMENTS

Each of the second to fourth embodiments has explained an example in which the edge widths of the left and right end portions are set to two pixels, but the present disclosure is not limited to this. For example, the edge width may be set to three or more pixels, and the same effect as in this embodiment is obtained even by setting different edge widths for the left and right end portions. This configuration can be implemented by setting different pixels determined as the left end portion “1” and the right end portion “2” in step S303.

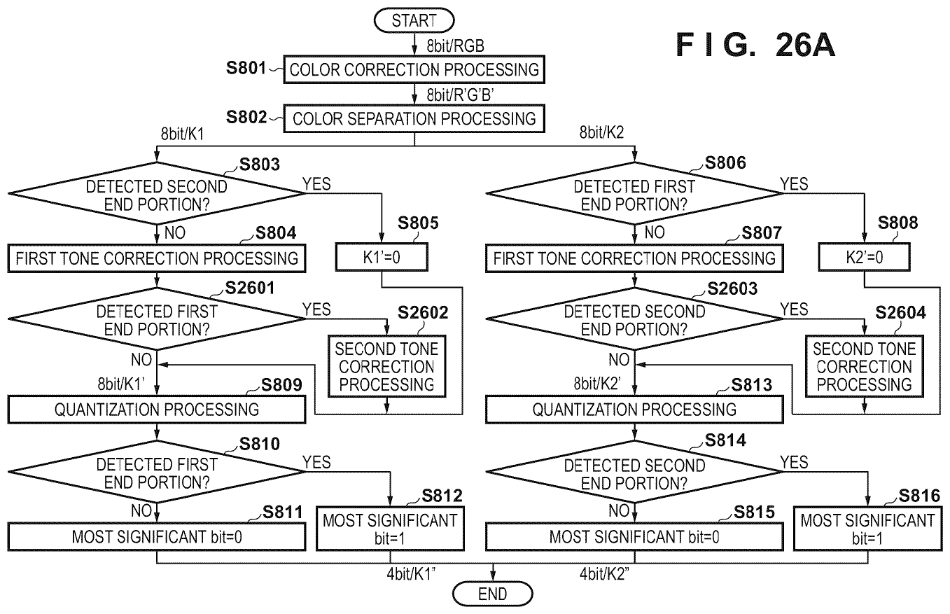

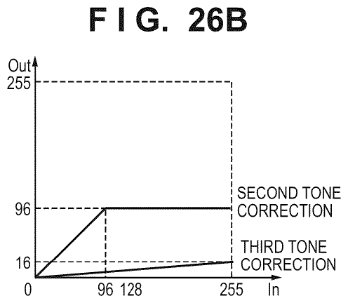

Each of the above-described embodiments has explained the configuration in which dots are not thinned with respect to a nozzle array used in pixels each determined as a specific end portion by the image analysis unit 210, but the present disclosure is not limited to this. This configuration can be implemented by a flowchart shown in FIG. 26A and tone correction shown in FIG. 26B. The difference between FIG. 26A and FIG. 6 described above is that processes of steps S2601 and S2602 are added after step S804 and processes of steps S2603 and S2604 are added after step S807. In steps S2601 and S2602, only if a processed pixel is in the first end portion, a color separation/quantization unit 211 further performs second tone correction processing for a density value K1′ having undergone first tone correction processing in step S804. Similarly, in steps S2603 and S2604, only if a processed pixel is in the second end portion, the color separation/quantization unit 211 further performs second tone correction processing for a density value K2′ having undergone first tone correction processing in step S807. FIG. 26B is a graph showing a setting example of the second tone correction processing, in which In represents the density values K1′ and K2′ before processing and Out represents the processed density values K1′ and K2′. In the second tone correction processing, In=Out is obtained until In becomes a predetermined tone value (96 in FIG. 26B), and Out is constant for In above the predetermined tone value. Since this can decrease the density value of the end pixel, dots can be thinned with respect to a nozzle array used in pixels each determined as specific end portion by an image analysis unit 210.

Furthermore, each of the above-described embodiments has explained an example of so-called complete exclusion in which the left end pixels and their adjacent pixels use only the Ev nozzle array and the right end pixels and their adjacent pixels use only the Od nozzle array, but the present disclosure is not limited to this. For the purpose of, for example, holding the density of the end pixels, printing may be executed by using both the nozzle arrays for only some pixels in the left and right end portions without impairing the line width formed on the print medium. For example, this can be implemented by replacing steps S805 and S808 of FIG. 6 by third tone correction processing shown in FIG. 26B. In the third tone correction processing, In represents the density values K1 and K2, Out represents the processed density values K1′ and K2′, and a slope Out/In is sufficiently smaller than 1.

Furthermore, each of the above-described embodiments has explained an example in which an arbitrary quantization table is used in quantization of density value data, but the Ev nozzle array, the Od nozzle array, and the discharge position adjustment values thereof may be correlated. FIG. 25A shows the processing which is executed by the color separation/quantization unit 211 before performing the quantization processing in step S813. The color separation/quantization unit 211 first acquires, in step S2501, the discharge position adjustment value set in step S501, and calculates, in step S2502, a relative shift amount Z between the Ev nozzle array and the Od nozzle array. In this case, Z is positive in a case where the dot of the Od nozzle is relatively shifted in the −X direction with respect to the Ev nozzle. Next, in step S2503, the color separation/quantization unit 211 calculates Dz=Z/(resolution of discharge position adjustment value/printing resolution) as the shift amount in the quantization table. At this time, Dz may be obtained by rounding down or rounding off the fraction portion. Then, in step S2504, the color separation/quantization unit 211 generates a table by shifting, in the −X direction by Dz columns, the quantization table applied to the Ev nozzle array in step S809, and sets the generated table as a quantization table to be applied to the Od nozzle array. More specifically, if the quantization table shown in FIG. 25B is used in step S809 and Dz is 1, the quantization table shown in FIG. 25C is set as a quantization table to be applied to the Od nozzle array. Alternatively, if a read start position in the table in step S809 is a position 2505, the same quantization table is set for the Od nozzle array, and the read start position in the table may be set to a position 2506. Thus, even if the discharge position adjustment value is set in step S501, the quantization table can be applied in correspondence with the adjusted dot position, and thus the graininess in a case where the input image is a halftone image can be made substantially constant regardless of the adjustment value.

Furthermore, each of the above-described embodiments has explained an example of performing conversion into 3-valued data in quantization of density value data but the present disclosure is not limited to this as long as the characteristic and configuration are the same. The density value data may be converted into binary data or 4- or more-valued data. Each of the above-described embodiments assumes that the printhead includes the Ev nozzle array and the Od nozzle array which are different in position in the Y direction but the present disclosure is not limited to this as long as the characteristic and configuration are the same. In the above-described embodiments, if a plurality of nozzle arrays are arrayed at the same position in the Y direction, each embodiment is applicable.

Each of the above-described embodiments has explained a serial-type image processing apparatus but the present disclosure is not limited to this as long as the characteristic and configuration are the same. A line-type printhead may be used or a serial-type apparatuses may be arranged vertically. Furthermore, each of the above-described embodiments has explained an inkjet printer but the present disclosure is not limited to this as long as the characteristic and configuration are the same. For example, a laser printer using toner or a copying machine may be adopted.

Each of the above-described embodiments has explained a bitmap data area or the like as an area in a RAM but the present disclosure is not limited to this and any rewritable storage device may be used. For example, an HDD or an Embedded Multi Media Card (eMMC) separated from the RAM may be provided, and an entire data area or part of it may be arranged in a memory area of the HDD or eMMC.

Each of the above-described embodiments has explained that image processing including edge processing is executed in the image forming apparatus 10 but the present disclosure is not limited to this as long as the characteristic and configuration are the same. More specifically, part or all of the image processing including the edge processing may be performed by an apparatus outside the image forming apparatus 10, and then subsequent processing may be performed in the image forming apparatus 10 based on the processing result.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-167826, filed Sep. 26, 2024 which is hereby incorporated by reference herein in its entirety.

What is claimed is:

1. An image processing apparatus comprising:
a print unit configured to print dots on a print medium by discharging ink droplets on the print medium, and configured to be able to print dots at a resolution higher than a resolution of image data and relatively move in a scanning direction with respect to the print medium; and
a dot arrangement unit configured to perform processing of arranging a dot in a pixel based on the image data including an object,
wherein the print unit includes a first nozzle array configured to be able to print a dot in a first region of each pixel of the object, and a second nozzle array configured to be able to print a dot in a second region of each pixel of the object, and the first region and the second region are arranged in a direction orthogonal to the scanning direction,
as a result of the processing by the dot arrangement unit, dots are arranged so that in a first edge pixel group located in a first end portion of the object in the scanning direction and adjacent to a boundary between the object and an outside of the object, a ratio of arranging dots in the second regions is lower than a ratio of arranging dots in the first regions, and in a second edge pixel group adjacent to the boundary and located in a second end portion different from the first end portion and on a opposite side of the first end portion in the scanning direction, a ratio of arranging dots in the first regions is lower than a ratio of arranging dots in the second regions, and
a positional relationship between an array of the dots arranged in the first regions of the pixels in the scanning direction of the object and an array of the dots arranged in the second regions of the pixels in the scanning direction of the object is uniformly shifted in the scanning direction so that a width in the scanning direction of the object is narrow.

2. The apparatus according to claim 1, wherein
the dots are arranged in the first regions of all first edge pixels included in the first edge pixel group of the first end portion, and
the dots are arranged in the second regions of all second edge pixels included in the second edge pixel group of the second end portion.

3. The apparatus according to claim 2, wherein
no dots are arranged in the second regions of all the first edge pixels of the first end portion, and
no dots are arranged in the first regions of all the second edge pixels of the second end portion.

4. The apparatus according to claim 1, wherein
dots are arranged in at least some of the first regions of all the first edge pixels included in the first edge pixel group of the first end portion, and
dots are arranged in at least some of the second regions of all the second edge pixels included in the second edge pixel group of the second end portion.

5. The apparatus according to claim 4, wherein
no dots are arranged in the second regions of all the first edge pixels of the first end portion, and
no dots are arranged in the first regions of all the second edge pixels of the second end portion.

6. The apparatus according to claim 1, wherein
an amount of the shift is smaller than one pixel.

7. The apparatus according to claim 1, wherein
a center of gravity of each dot arranged in the first region of each pixel in the scanning direction of the object is located at a center of each pixel in the scanning direction.

8. The apparatus according to claim 1, wherein
a center of gravity of each dot arranged in the first region of each pixel in the scanning direction of the object is shifted in a first direction from a center of each pixel in the scanning direction,
a center of gravity of each dot arranged in the second region of each pixel in the scanning direction of the object is shifted in a second direction from the center of each pixel in the scanning direction, and
the first direction and the second direction are opposite directions in the scanning direction.

9. The apparatus according to claim 1, wherein
in a case where the ink droplet is separated into a main droplet and a satellite, a dot printed on the print medium includes a satellite dot printed on the print medium by the satellite.

10. The apparatus according to claim 9, wherein
even in a case where a dot in the second region of a pixel adjacent to a first edge pixel included in the first edge pixel group inside the object includes the satellite dot, the satellite dot is printed inside the object in the scanning direction relative to a dot in the first region of the first edge pixel.

11. The apparatus according to claim 9, wherein
even in a case where a dot in the first region of a pixel adjacent to a second edge pixel included in the second edge pixel group inside the object includes the satellite dot, the satellite dot is printed inside the object in the scanning direction by to a dot in the second region of the second edge pixel.

12. The apparatus according to claim 9, wherein
as a result of the processing by the dot arrangement unit,
even in pixels located inside the object with respect to the first edge pixels included in the first edge pixel group, a ratio of arranging dots in the second regions is lower than a ratio of arranging dots in the first regions, and
even in pixels located in the object on an inner side of the second edge pixels included in the second edge pixel group, a ratio of arranging dots in the first regions is lower than a ratio of arranging dots in the second regions.

13. The apparatus according to claim 1, wherein
in a case where the ink droplet is separated into a main droplet and a satellite, a dot printed on the print medium includes no satellite dot printed on the print medium by the satellite.

14. The apparatus according to claim 13, wherein
as a result of the processing by the dot arrangement unit,
even in pixels located inside the object with respect to the first edge pixels included in the first edge pixel group, a ratio of arranging dots in the second regions is lower than a ratio of arranging dots in the first regions, and
even in pixels located inside the object with respect to the second edge pixels included in the second edge pixel group, a ratio of arranging dots in the first regions is lower than a ratio of arranging dots in the second regions.

15. The apparatus according to claim 1, wherein
an amount of the shift of the positional relationship in the scanning direction in a case where the image processing apparatus operates in a second print mode is smaller than an amount of the shift of the positional relationship in the scanning direction in a case where the image processing apparatus operates in a first print mode.

16. The apparatus according to claim 1, wherein
in a case where the image processing apparatus operates in a first print mode, the positional relationship is changed to be shifted in the scanning direction, and in a case where the image processing apparatus operates in a second print mode, the positional relationship remains unchanged.

17. The apparatus according to claim 15, wherein
the object includes a third end portion in a direction orthogonal to the scanning direction and a fourth end portion on an opposite side of the third end portion in the direction,
the second print mode is a print mode in which in each of a third edge pixel group located in the third end portion and adjacent to the boundary and a fourth edge pixel group located in the fourth end portion and adjacent to the boundary, a ratio of arranging dots in regions farther from the boundary among the first regions and the second regions is lower than a ratio of arranging dots in regions closer to the boundary, and
the first print mode is a print mode in which in each of the third edge pixel group and the fourth edge pixel group, a ratio of arranging dots in regions closer to the boundary among the first regions and the second regions is lower than a ratio of arranging dots in regions farther from the boundary.

18. The apparatus according to claim 1, further comprising a quantization unit configured to perform, based on the image data, quantization processing using a quantization table in which quantization values are set,
wherein the quantization unit performs the quantization processing for the first region using a first quantization table, and
the quantization unit performs the quantization processing for the second region using a second quantization table.

19. The apparatus according to claim 18, wherein
the second quantization table is a quantization table created from the first quantization table based on an amount that is changed to shift the positional relationship in the scanning direction.

20. An image processing apparatus comprising:
a print unit configured to print dots on a print medium by discharging ink droplets on the print medium, and configured to be able to print dots at a resolution higher than a resolution of image data and relatively move in a scanning direction with respect to the print medium;
a detection unit configured to detect edge pixels adjacent to a boundary between an object and an outside of the object;
a quantization unit configured to perform quantization processing based on the image data including the object; and
a dot arrangement unit configured to perform processing of arranging a dot in a pixel using a dot arrangement pattern corresponding to a quantization value having undergone the quantization processing,
wherein the print unit includes a first nozzle array configured to be able to print a dot in a first region of each pixel of the object, and a second nozzle array configured to be able to print a dot in a second region of each pixel of the object, and the first region and the second region are arranged in a direction orthogonal to the scanning direction,
the detection unit detects a first edge pixel group located in a first end portion of the object in the scanning direction and a second edge pixel group located in a second end portion, different from the first end portion, on an opposite side of the first end portion in the scanning direction, and
the dot arrangement unit
arranges dots so that in a first edge pixel group, a ratio of arranging dots in the second regions is lower than a ratio of arranging dots in the first regions, and in a second edge pixel group, a ratio of arranging dots in the first regions is lower than a ratio of arranging dots in the second regions, and
uniformly shifts, in the scanning direction so that a width in the scanning direction of the object is narrow, a positional relationship between an array of the dots arranged in the first regions of the pixels in the scanning direction of the object and an array of the dots arranged in the second regions of the pixels in the scanning direction of the object.

21. The apparatus according to claim 20, wherein
in a case where the object is an object having no predetermined pixel width in the scanning direction, the detection unit performs no detection.

22. The apparatus according to claim 20, wherein
in a case where the object is an object having a 2-pixel width in the scanning direction, any of pixels in a direction of the pixel width is not detected as the edge pixel by the detection unit.

23. The apparatus according to claim 20, wherein
in a case where the object is an object having a 3-pixel width in the scanning direction, a central pixel in a direction of the pixel width is not detected as the edge pixel by the detection unit.

24. The apparatus according to claim 20, wherein
in a case where the object is an object having a 3-pixel width in the scanning direction, a central pixel in a direction of the pixel width is detected as the edge pixel by the detection unit.
